(19) United States
(12) Patent Application Publication
(10) Pub. No.: US 2007/0150327 A1
(43) Pub. Date: Jun. 28, 2007

(54) Project management method and system

(75) Inventor: Diane Dromgold, Sydney (AU)

Correspondence Address: TIAJOLOFF & KELLY, CHRYSLER BUILDING, 37TH FLOOR, 405 LEXINGTON AVENUE, NEW YORK, NY, 10174, US

(73) Assignee: RNCC Global Projects, Notrh Sydney (AU)

(21) Appl. No.: 10/582,824

(22) PCT Filed: Jan. 21, 2005
(86) PCT No.: PCT/AU05/00068

§ 371 Date: Jun. 14, 2006

(30) Foreign Application Priority Data
Jan. 21, 2004 (AU) 2004900569
Oct. 1, 2004 (AU) 2004905709

(51) Int. Cl. G06F 9/46

(52) U.S. Cl. 705/8

(57) ABSTRACT

A computer based method and system is provided for facilitating the management of a project. The method includes receiving task data, associated resource data, associated timing data and associated task-related dependency data. This data is typically arranged to be viewed in a task-centric manner through a task-centric display interface where for each task or event all corresponding resources and a series of attributes associated with the tasks or events including the timing of the tasks or events, the human resources allocated to the tasks or events and task related dependency links. The task, timing and task-related dependency data is then grouped for each resource and the entries may be stored in a data store. The grouped data is then graphically represented on a resource-centric display interface from a resource-centric perspective as a compilation of a project management plan so that for each resource, the task, timing and task-related dependency data is collectively displayed relative to said resource in a one-to-many relationship.

### FIELD OF THE INVENTION

The invention relates to a method and system for assisting in the management of projects.

### BACKGROUND OF THE INVENTION

Over the years, various systems, methods and tools have been used in project management across various sectors including engineering, construction, and, more recently, in IT and corporate and government organizations.

One of the main problems associated with project management is the relatively high failure rate of projects. Recent estimates of the failure rate for projects in the corporate, government and IT sectors have varied between 75 percent and 83 percent. This is despite a significant body of knowledge in the area of project management having been developed over the years. Gantt charts have become the default standard layout for assisting in project management in these areas.

A simplified version of Gantt chart is set out at 10 in FIG. 1. A series of broad tasks 12 and 13 are listed in the leftmost task column, and various start and end dates 14 are listed along the uppermost timing row. The broad tasks 12 and 13 are divided up into more detailed tasks 12.1 to 12.4 and 13.1 to 13.5, each one of which has an associated bar 12.1a, 12.2a which is indicative of how long the task is expected to take. The human resources that need to be applied to each task typically appear in a box alongside each bar, as is shown at 12.1b and 12.2b. Names of individuals allocated to tasks typically appear in a number of different boxes. Dependency links between task bars are indicated by arrows 24. A list of all those individuals involved in the project appears in a resource column 25 to the immediate right of the detailed task column.

Whilst a Gantt chart and associated project management software such as Microsoft Project® and Primavera provide a fairly clear visual indication of each main task, its duration, its interdependency and the applicable resource set or team which needs to be applied to each task, the inventor has concluded that the relatively high recorded failure rate is indicative of systemic problems existing in the area of project management and of possible shortcomings in the conventional Gantt chart and underlying project management software as the primary project management tools.

### SUMMARY OF THE INVENTION

In broad terms, the invention is directed towards a project management system and method which is focused on the individuals or teams associated with the events or performing the tasks rather than the events or tasks per se. The primary building blocks are accordingly the individuals or teams involved in the project, and their individual capacity and ability with respect to the events/tasks making up the project. Whilst dependency links are still event- or task-based, the links are made between individuals or teams responsible for completing and initiating tasks, thereby to devolve responsibility and accountability on to individuals or teams.

Not only is the project plan presented in such a way that each individual in the project can view immediately what his or her tasks are and how the initiation and completion of these tasks or events depend on or are depended on by other individuals involved in the project, but also the overall construction of the plan is based on the availability and ability of individuals or teams. As a result, the overall project management method involves deconstruction of the project to an individual/team tasks level and reconstruction of the individual/team tasks and timing after an iterative individual- or team-based consultative process has occurred.

According to one aspect of the invention there is provided a computer-based method of facilitating the management of a project including:

providing a project management database configured to receive a plurality of entries, including a series of tasks or events and a series of attributes associated with the tasks or events, the attributes including time-based attributes indicating the timing of the tasks or events, and resource-based attributes indicating at least the human resources allocated to the tasks or events;

generating at least a resource-centric display interface from the database in which each human resource is listed against its associated tasks, time-based attributes and task-related dependency links in a one-to-many relationship;

storing entries in the database; and

compiling a project management plan in which tasks, associated time-based attributes and dependency links are grouped in respect of each human resource.

In a preferred form of the invention, the method may also include generating and displaying project sub-plans for each individual human resource,

enabling the project sub-plans to be modified, and

combining the modified sub-plans into an overall modified project management plan in which the tasks dependency links and associated time-based attributes are listed for each of the human resources.

In yet another aspect of the invention, the method may include

receiving task data, associated resource data, associated timing data and associated task-related dependency data, said data being arranged to be viewed in a task-centric manner through a task-centric display interface in which each for each task all corresponding resources are grouped;

for each resource, grouping all corresponding task, timing and task-related dependency data,

graphically representing said grouped data on a resource-centric display interface from a resource-centric perspective so that for each resource the task, timing and task-related dependency data is collectively displayed relative to said resource in a one-to-many relationship.

The invention also includes a method for facilitating the management of multiple projects, each project having a series of tasks, said method comprising:

receiving a plurality of project management datasets, each dataset including project data, task data, associated resource data, associated timing data and task-related dependency data with said data being viewable through a task-centric graphical interface,

for each resource, grouping all corresponding task, timing and dependency data,

graphically representing said grouped data on a resource-centric interface so that for each resource, the project, task timing and dependency data is collectively displayed in a one-to-many relationship relative to said resource.

Preferably, the method for facilitating the management of multiple projects includes, at a resource-centric level, also includes enabling individual tasks to be re-allocated to other resources, typically via a resource-centric interface.

Preferably the method for facilitating the management of multiple projects further includes enabling said resource-centric project management dataset to be alternately displayed in a task-centric format, where for each task the resource and timing data is collectively displayed.

In still a further aspect of the present invention, there is provided a computer-based method for planning a project including:

receiving a project management dataset including task data, associated human resource data and associated timing data,

for each human resource, grouping all corresponding task, timing and dependency data,

providing a resource-centric interface wherein said grouped data is graphically represented from a resource-centric perspective so that for each resource, the task and timing data are collectively displayed relative to said resource in a one-to-many relationship,

capturing modifications to said graphical representation and adjusting corresponding task and/or timing data,

storing modified task and/or timing data.

In a further aspect of the present invention there is provided a computer-based method for planning a project including:

receiving a project management dataset including task data, associated human resource data, associated timing data and associated task-related dependency data;

deconstructing and regrouping the project management dataset for each human resource so that it is grouped with its corresponding task, timing and dependency data,

graphically representing said grouped data so that for each resource, the task, timing and dependency data are collectively displayed relative to said resource in a one-to-many relationship.

Preferably both the project management plan and the individual plans making up the project management plan are arranged in a Gantt chart-type format, with each resource and associated task and timing data being row-specific.

Conveniently the dependency links are linked both to tasks allocated to the same human resource as well to tasks allocated to other human resources.

At least some of the human resources may be comprised of teams of individuals who may be assigned to sub-projects.

The resources-based attributes may include non-human resources required in the implementation of the project, chosen from a group including equipment, supplies, premises, and associated costs.

Conveniently the task data is represented as a series of tasks, and said task-related dependency data is represented as a series of incoming and outgoing dependency links, each incoming link originating from tasks allocated to a human resource on which a particular task depends, and each outgoing link being directed to a task depending on said particular task.

The invention extends to a system for carrying out any of the above methods.

The invention further provides a computer based system for facilitating the computer-based management for a project including:

a data store for storing a project management dataset, said project management dataset including task data, resource data, timing data and dependency data;

a task-based project management application which is arranged to access said data store, and to allow the graphical display and manipulation of said dataset in a task-centric manner, in which said application graphically displays the associated data for each task,

a resource-based project management application which is arranged to access said data store, and which groups for each resource all corresponding task, timing and dependency data in a resource-centric manner, so each resource is linked with its task and timing data in a one-to-many relationship, and

a graphical representation means for graphically representing said resource-centric data such that each resource is linked with its tasks, timing and dependency data in a one-to-many relationship.

In yet another aspect of the invention, there is provided a system for facilitating the computer-based management for a project including:

a project management application which stores a series of data on tasks in a first data store, each task having associated resource, timing and dependency data, said application graphically displaying data associated with each task in a task-centric format,

a function integrated within the project management application which is able to access the said first data store, and which aggregates data associated with each resource and stores it in a second data store, so that each resource is linked with its task timing and dependency data in a one-to-many relationship,

a graphical representation means adapted to generate a graphical representation of either the first or second data stores, and

means for switching between graphical representations of the task-centric or resource-centric views.

In still a further aspect of the present invention there is provided a system for facilitating the computer-based management for a project including a data store for storing a project management dataset, said project management dataset including task data, resource data dependency, and timing data, and

a task-based project management application which is arranged to access said data store, and to allow the graphical display and manipulation of said dataset in a task-centric manner, in which said application graphically displays the associated data for each task, and

a resource-based project management application which is arranged to access said data store, and which is arranged to group for each resource all corresponding task and timing data in a resource-centric manner, so each resource is linked with its task and timing data in a one-to-many relationship, said application including or interfacing with a graphical representation means for graphically representing said resource-centric data such that each resource is linked with its tasks, timing and dependency data in a one-to-many relationship.

In still another aspect of the present invention, there is provided a system for facilitating the computer-based management of a project, having a series of tasks, said system comprising:

means for storing a project management dataset, said project management dataset including task data, resource data timing data and dependency data;

means for accessing said dataset, graphically displaying the associated data for each task and manipulating said dataset in a task-centric manner,

many means for accessing and reorganising and/or updating said dataset, said reorganising and/or updating including grouping task and timing data in a resource-centric manner, so each resource is linked with its task and timing data in a one-to-many relationship,

many means for graphically representing said resource-centric data such that each resource is linked with its task, timing and dependency data in a one-to-many relationship.

In still a further aspect of the present invention there is provided a system for facilitating the computer-based management of multiple projects including:

a plurality of data stores for storing a plurality of project management datasets, each dataset including project data, task data, associated resource data and associated timing data,

a resource-based project management application which is arranged to access said plurality of data stores, and which is arranged to group for each resource all corresponding task and timing data in a resource-centric manner, so each resource is linked with its task and timing data in a one-to-many relationship,

a graphical representation means for graphically representing said resource-centric data such that for each resource, project, task timing and dependency data for that resource across each project is collectively displayed in a one-to-many relationship relative to said resource.

Preferably the system includes a plurality of display interfaces, each display interface having individual human resources listed against events or tasks associated with that resource.

Conveniently the system includes means for enabling dependency-based links to be inserted between dependent tasks or events associated with the human resources.

In still a further aspect of the present invention there is provided a computer readable media containing program code, the program code being operative to instruct at least one programmable processor to execute a resource-based project management application which is arranged to access a data store associated with a project, and which is arranged to group for each resource in that project all corresponding task, timing and dependency data in a resource-centric manner, so each resource is linked with its task, timing and dependency data in a one-to-many relationship, said application including or interfacing with program code capable of graphically representing said resource-centric data such that for each resource, task, timing and dependency data for that resource, is collectively displayed in a one-to-many relationship relative to said resource.

In still yet another aspect of the present invention, there is provided a computer readable media containing program code, the program code being operative to instruct at least one programmable processor to execute a resource-based project management application which is arranged to access data stores associated with a plurality of specified projects, and which groups for each resource all corresponding task, timing and dependency data in a resource-centric manner, so each resource is linked with its task, timing and dependency data in a one-to-many relationship, said application including or interfacing with program code capable of graphically representing said resource-centric data such that for each resource, project, task, timing and dependency data for that resource across each project, is collectively displayed in a one-to-many relationship relative to said resource.

### BRIEF DESCRIPTION OF THE DRAWINGS

FIG. 1 shows a simplified schematic diagram of a prior art Gantt chart;

FIG. 2 shows a schematic block diagram of the project management system of a first embodiment of the present invention;

FIG. 3 shows a flowchart of the overall project management process in accordance with the first embodiment;

FIG. 3A shows a first Gantt chart-type data entry interface forming part of the project management; process of FIG. 3

FIG. 3B shows a second data entry interface;

FIG. 3C shows a third data entry interface table in which individual tasks are separately allocated against individual resources;

FIG. 3D shows the table of FIG. 3C including dependency links;

FIG. 3E shows a user interface incorporating a personalised task list for an individual in the project;

FIG. 3F shows a modified task list for the individual;

FIG. 3G shows a modified user interface in the form of a table similar to that of FIG. 3D but after the allocation of tasks has been validated with the individuals scheduled to do the work;

FIG. 4 shows a flowchart illustrating the steps involved in implementing the project management method and system of a first embodiment of the invention;

FIG. 5 shows a diagram of the main tables involved in a relational database forming part of the project management system of a first embodiment of the present invention;

FIG. 6 shows the diagram of FIG. 5 with a series of exemplary links inserted;

FIG. 7 shows a table of a sample progress report by person or resource, and

FIG. 8 shows a table of a sample progress report by task.

FIG. 9 is a high level architecture diagram of a second embodiment of the present invention;

FIG. 10 is a sample data structure used in a related art task centric Project Management System;

FIG. 11a is a sample data structure employed by a second embodiment of the present invention which is resource-centric;

FIG. 11b is a sample data structure employed by a third embodiment of the present invention which is resource centric, where the individual resources are involved across multiple projects.

FIG. 12a is a screen shot of the resources used in a typical project in an allocation screen in a related art project Management System;

FIG. 12b is a screen shot of a Gantt chart corresponding to the project shown in a typical related art project management system in FIG. 12a.

FIG. 13 is a screen shot of a reorganised resource-centric Gantt used in a second embodiment of the present invention;

FIG. 14 is a screen shot which shows that information associated with a specific task which appears when a region of a chart of the second embodiment of the present invention is selected;

FIG. 15 is a screen shot of a second embodiment of the present invention prior to reallocation of a task;

FIG. 16 is a screen shot of a second embodiment of the present invention which shows reallocation of the task to another resource;

FIG. 17 is a screen shot of a second embodiment of the present invention which shows information on the reallocated task;

FIG. 18 is a screen shot of a second embodiment of the present invention which shows the reallocated task;

FIG. 19 shows a screen shot of project management software that reflects a resource which has been reallocated in accordance with a second embodiment of the present invention; and

FIG. 20 shows a screen shot of project management software that reflects a resource which has been reallocated in accordance with a second embodiment of the present invention.

### DETAILED DESCRIPTION OF THE EMBODIMENTS

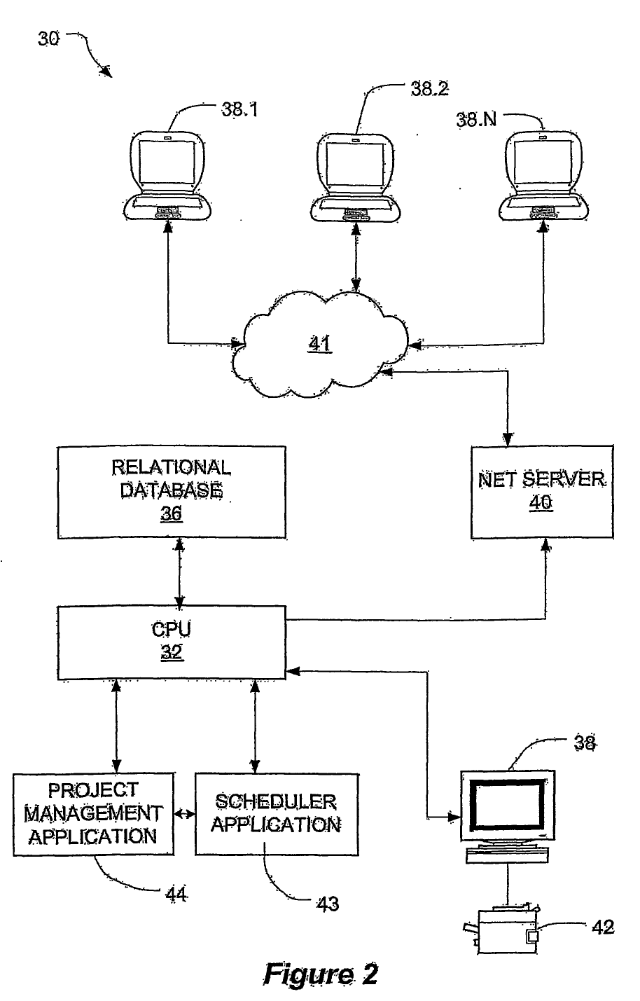

Referring now to FIG. 2, a high-level diagram of the architecture of a project management system 30 is shown, including a CPU 32, linked to a relational database 36. The CPU is operated via a computer terminal 38 providing a standard user interface, and is also linked to a communications interface in the form of a net server 40 communicating over a local and/or wide area network 41 such as the internet with a number of remote computer terminals 38.1 to 38.N. The computer terminal 38 is linked to a printer 42.

The relational database 36 includes entries in a memory structure for receiving data associated with a project, including a task data set incorporating all of the main and sub-tasks associated with the project, and a series of attribute data sets. These include a timing data set including start and end times and dates associated with each of the tasks, a human resource data set including the list of people to be involved in the project and their availability and potential utilization over the period, a non-human resource data set including all significant non-human resources required, such as all plant, equipment and supplies which need to be pre-allocated or shared, and a dependency data set including details of dependencies between tasks. The relational database 36 is typically implemented with a commercial software relational database application that is SQL compliant and can handle binary large objects, such as Interbase. Operation of the relational database is controlled by a scheduler application 43. A project management application 44 also controls the operation of the relational database, and can be integral with or separate from the scheduler application.

This application may either be a commercial project management tool that exists outside the scheduler application 43 e.g. Microsoft Project or Primavera; or a custom built project management tool created specifically to facilitate the scheduler application. The scheduler application 43 may be arranged to work with already commercially available project management systems.

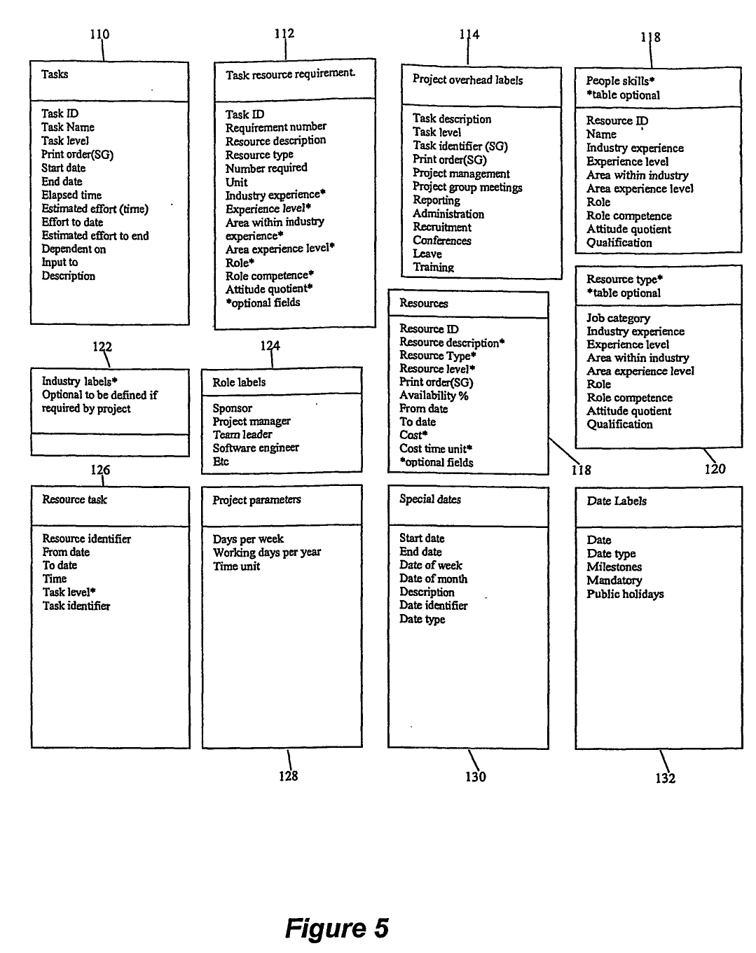

The abovementioned attribute data sets may be stored in the relational database 36 in tabular form, as is clear from FIG. 5. The CPU 32 may include a notebook application for enabling changes to be made to attributes and tasks to be recorded, and for notes on the underlying reasons for the changes to be made where necessary.

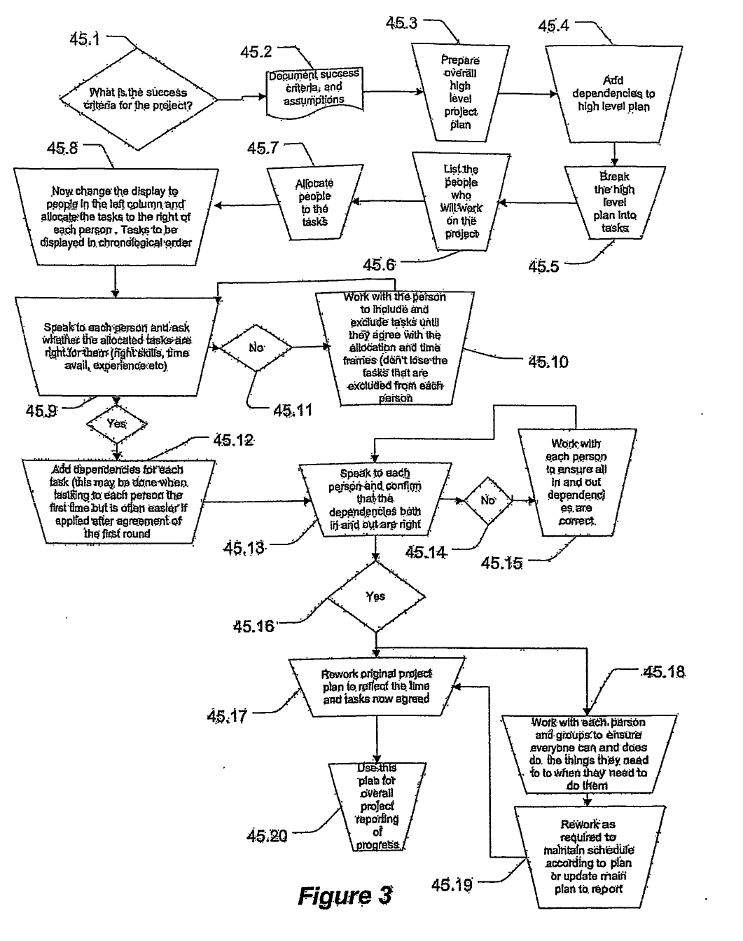

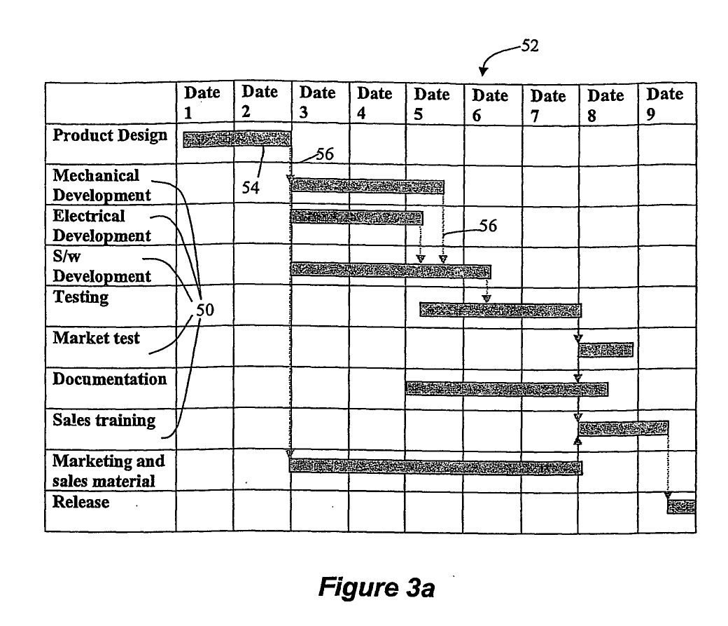

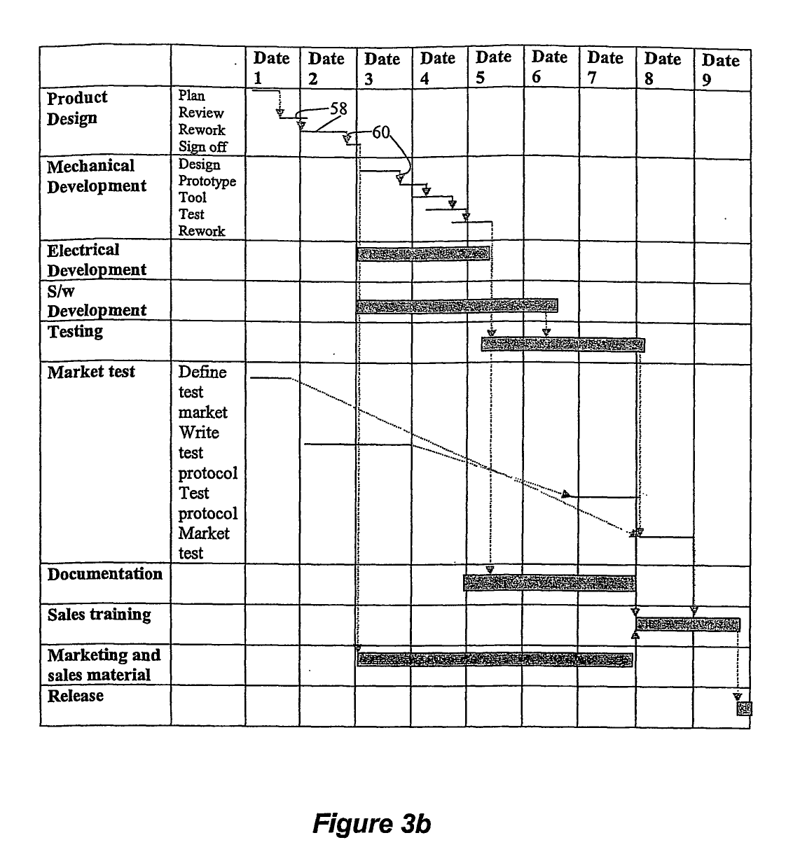

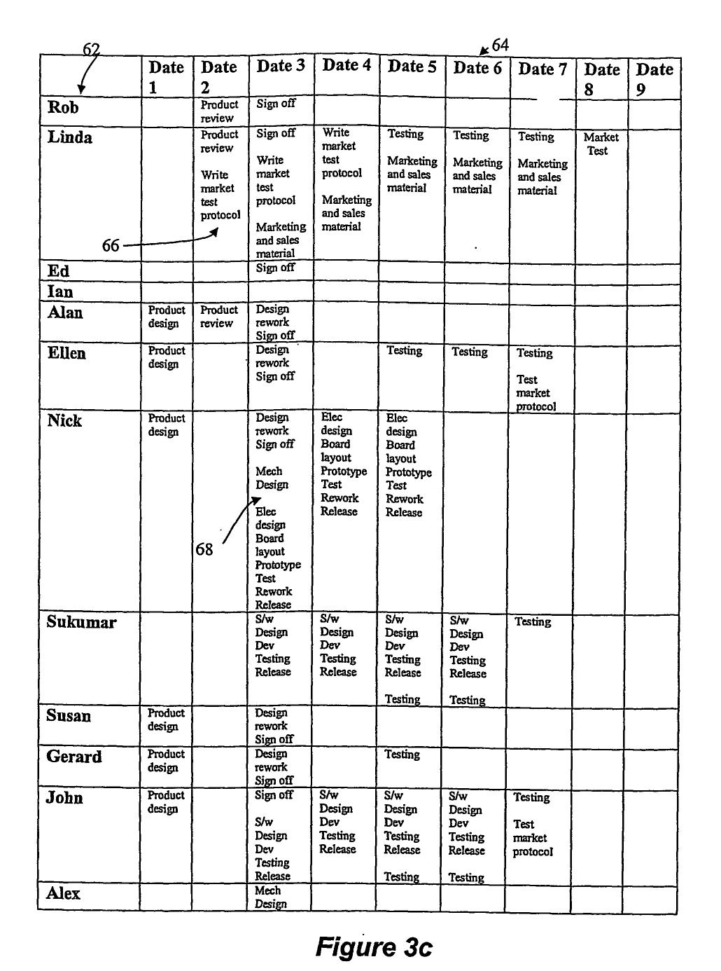

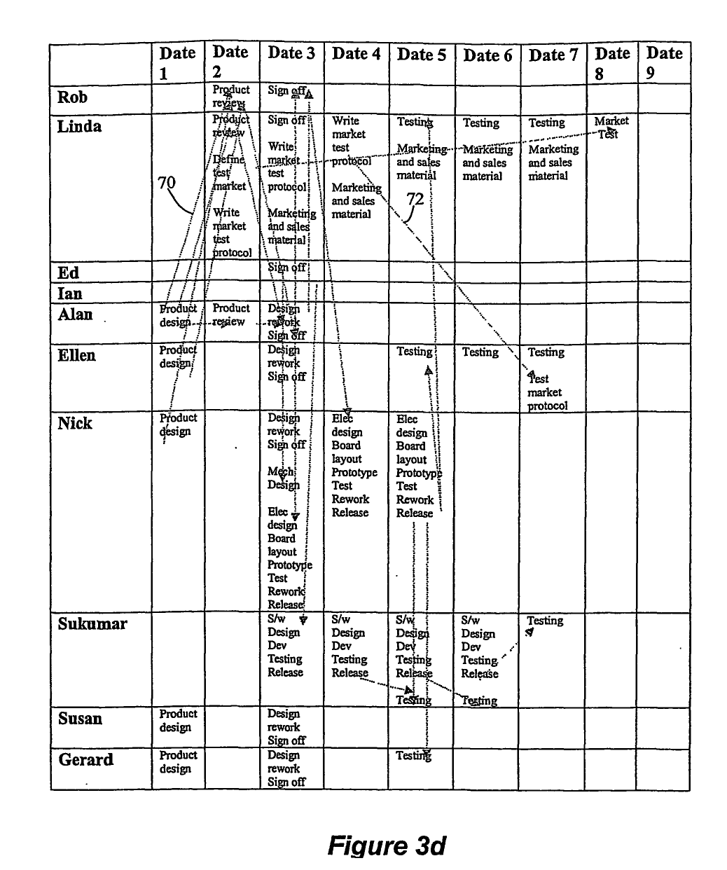

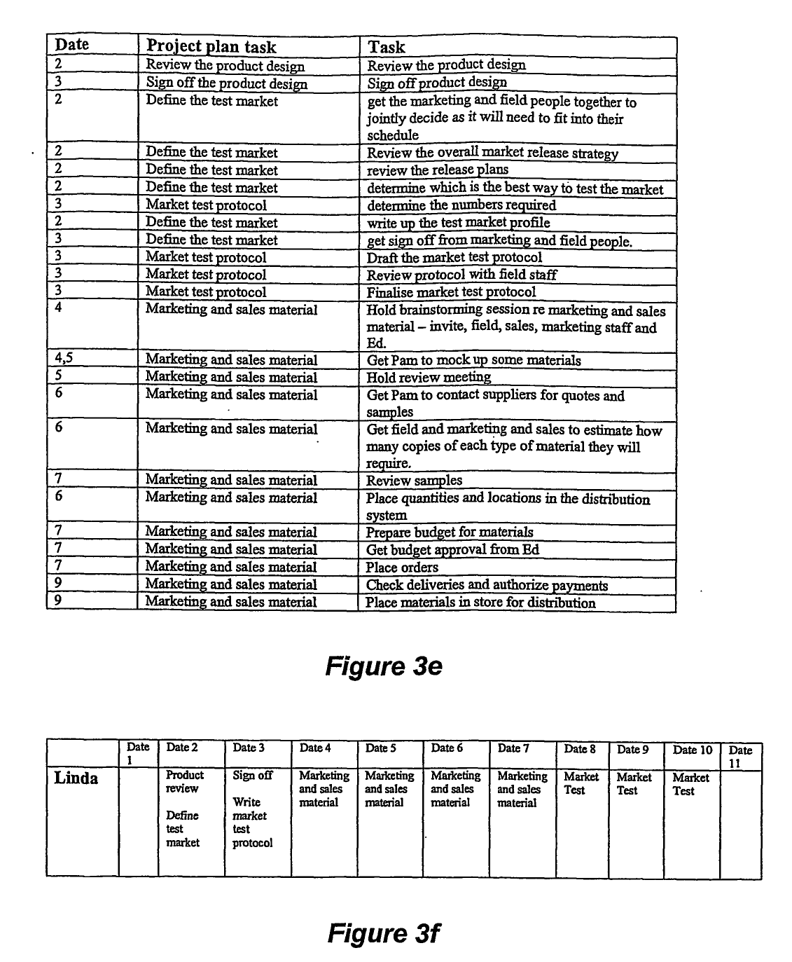

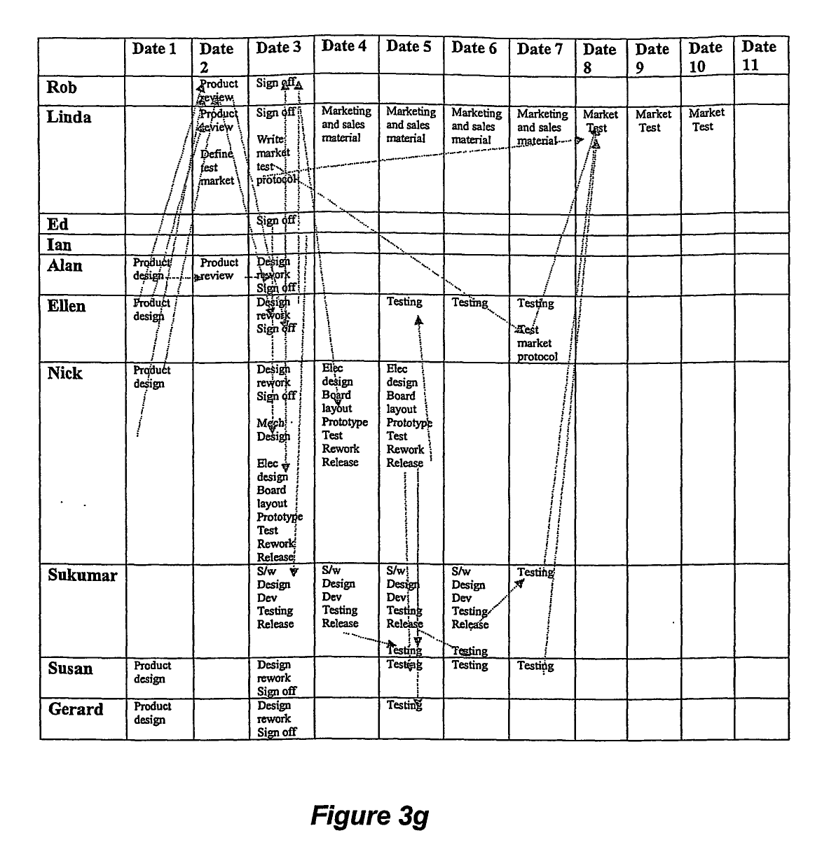

Referring first to FIG. 3, a flowchart of the overall project management process is shown reflecting the various steps which will be described in more detail with reference to FIGS. 3A to 3G. After success criteria assumptions for the project have been identified and documented at 45.1 and 45.2, an overall high level project plan is prepared at 45.3, and a Gantt-type chart is initially assembled, as shown in FIG. 3A. This includes an initial set of assumptions about what is required, by when, and which resources will be available to fulfil the tasks and project. Major work elements or tasks are identified in the leftmost column at 50, and the relevant dates and milestones are indicated at 52 in the uppermost row of the chart, with the bars 54 indicating that the duration of each main task, and the arrows 56 indicating the dependencies, as is indicated at step 45.4 in FIG. 3.

From the plan, a more detailed list of tasks is made, such as those listed in example 1 below, and indicated at 45.5.

### EXAMPLE 1

3/02/2004 Surface mount the boards
3/03/2004 Give Nic and Dejang a loaded board with through hole
20/02/04 Update BOM on Oracle
24/02/04 Confirm parts availability
URGENT
   24/02/04 Organise kitting of parts
   24/02/04 Confirm status of all parts, ie top cover, specs etc freeze
   26/02/04 Obtain status on Jig/tooling requirements
   26/02/04 review and Update Final Product Boms in Oracle
   28/02/04 Confirm all specs are published
   28/02/04 No more changes to BOMS in Oracle
   15/03/04 Document manufacturability of units and meeting with production
   15/03/04 Begin process FMEA
   28/03/04 Complete process FMEA
   28/03/04 Complete training of ACS2 personnel for production equivalent build

It will be appreciated that this is first pass at the task list, which will typically be worked on by the project manager in conjunction with a small team and the tasked individuals.

In FIG. 3B, a breakdown of the various main tasks into sub-tasks is indicated at 58, with dependency links being shown at 60.

Subsequently, all of the people available to work on the project are listed (see 45.6 in FIG. 3) and entered via the user terminal. It is also indicated alongside each person whether they are dedicated or shared, and if shared, what percentage of their time is likely to be available for the project. The project manager then performs a validation step to ensure that these people are actually available over the relevant time period. Details regarding their non-availability over the time period may also be entered.

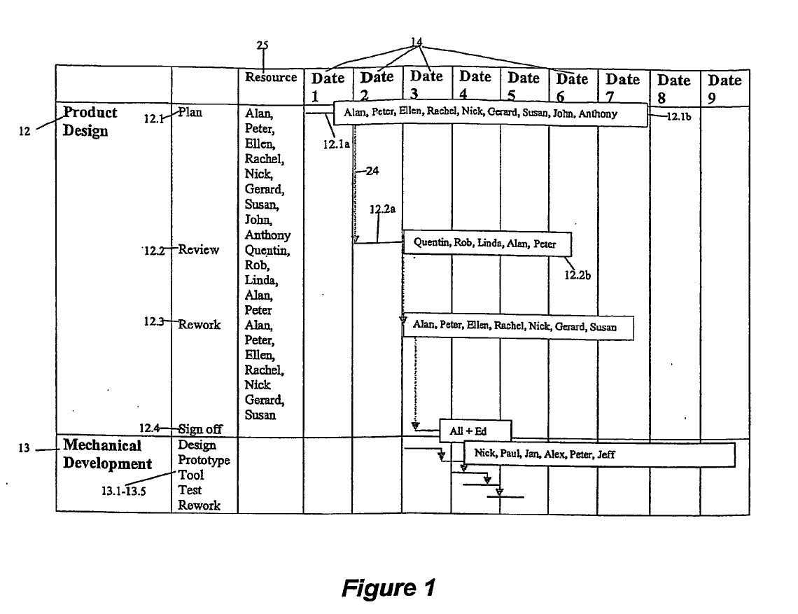

A chart or table of the type illustrated in FIG. 3C is then generated, with the individual people concerned being listed down the leftmost column, as is indicated at 62, and relevant dates and milestones being listed in the uppermost row of the table. The table is then populated with tasks against each of the relevant people within the constraints of the relevant dates and deadlines, as is shown at 45.7 and 45.8 in FIG. 3. At this stage, it starts to become clear who the key people are, where the shortages and excesses are, and what expected tasks have no one to do them. It also becomes clearer that there might be some people allocated to the project who are not really able to contribute to the extent required to achieve the outcome. It is also likely that some tasks will remain unallocated in the initial stages. The tasks can then be re-grouped in a different sequence to assist in determining the resources required. The table in FIG. 3C indicates one of the main aspects of the first embodiment of the present invention that differs over the traditional project management approach. By focusing on the available people for the project and allocating specific tasks to them in chronological order, each person can see what is expected of them without having to scan up and down the task-based project Gantt chart to see where their scattered names might appear in the relevant boxes 22.1, as is the case with FIG. 1. The table of FIG. 3C indicates clearly to each person whether or not the workload and timing of tasks is realistic. In certain cases, tasks may be misallocated due to the wrong skill set, and this will immediately become apparent when each individual views this table.

The project manager then interviews each person on the project team (45.9 in FIG. 3) with a view to assessing the allocation of tasks and uncovering tasks and commitments that the person needs to fulfil to complete his or her tasks. This step often results in a reality check when presumed data (which would under traditional project management approaches already have published to the organisation and the project team) are revised and some replanning can take place. This is represented at steps 45.9 to 45.11. Each person then knows what is required of them and has had input to ensure they will be able to do the job. At this stage, dependency links such as these shown at 70 and 72 may be added, as is shown at step 45.12. Dependency links indicate where one person's task is dependent on someone else finishing their task. After the project is set up and established the interdependent people and activities are those that the project manager will need to spend most time on. If these activities are completed on time then the project should proceed on time and any variations at any stage can either be accommodated through replanning or reported as an impact on the overall project.

It will be appreciated that significant editing and amending of the project management plan will generally be necessary at this point in time, particularly to ensure that dependencies are not inconsistent, and that none of the dependency links run backwards. After the dependency-based chart of FIG. 3D is finalised, individuals may be interviewed again with a view to ensuring that they are able and willing to perform what is required of them within the given time periods, and that all of the dependencies have been correctly identified and noted, as is shown at steps 45.13 to 45.16.

A personalised list of type illustrated in FIG. 3E is generated for each person involved in the project. FIG. 3E indicates a tabulated list generated for one of the team members, in this case Linda. Individual plans for each of the members of the project are similarly generated for review by the relevant individuals, for confirmation or modification.

In FIG. 3F, a modified table is shown in which certain modifications to Linda's task list have been made on the basis of her suggestions. For example, Linda has suggested dates I and 2 for defining the test market and writing the protocol and moving working on the marketing materials to date 3. Having pointed out that the testing and developing of marketing materials are simply incompatible, it is then suggested that Susan be used for testing as Linda is better at marketing. This is accordingly implemented. Linda also points out that the market test requires three dates and that this is not included on the plan. The project manager's assumption that the market testing can be conducted in one date is clearly incorrect. The market test cannot be brought forward as it is dependent upon completion of the product testing. This will have the effect of changing the release date and will need to be discussed with management before being implemented. The final round of modifications is shown at 45.17 to 45.20, though it will be appreciated that the processes are iterative, and are generally repeated, ideally until there is overall satisfaction and buy-in from all involved.

The table of FIG. 3G shows a modified view of FIG. 3D, with the table having been updated after the discussions with Linda and management, who have been made aware of the change in release date beforehand.

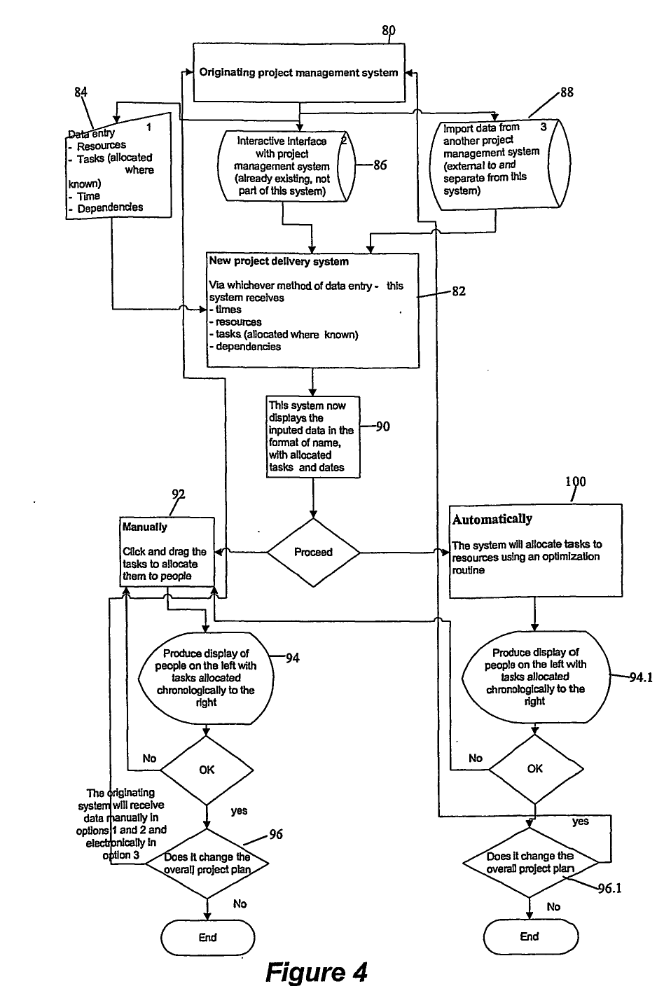

Referring now to FIG. 4, the various steps involved in implementing the system for different types of data entry are shown. In the flowchart, an originating project management system 80 is shown as a starting point. This may include a project management system implemented on a known project management scheduler application such as Microsoft® Project or Primavera®. The new project management system 82 of the invention may serve as an add-on to the originating system, in the form of the new project management application 44 and may receive data in a number of different ways from the originating system. As is shown at 84 data may be entered afresh into the relational database 36 of the new project management system to supplement the existing data. This may include resource data, task data, time data and dependency data. Alternatively, additional data may be incorporated by providing an interactive interface 86 with the existing project management system 80 which is designed to operate in conjunction with the new project management system 82. Stored data from an external originating system may also be imported separately from the originating project management system, as is shown at 88, by any known data transfer technique. This means that via whichever means appropriate, information can be entered into the new system to enable management of the project by monitoring, managing and supporting the allocated human resources.

The new project management system 82 according to the first embodiment of the present invention displays the input data in the format illustrated in FIG. 3C, as is shown at 90. In a manually based version, the allocation of tasks to different resources is implemented using a click-and-drag routine, as is shown at 92, thereby ending up with the modified display similar in form to that of FIGS. 3C and 3D, in which the dependencies have been inserted, with human resources being displayed in the left-most column and tasks allocated chronologically to the right of each resource, as is indicated at 94. The click-and-drag routine is repeated until task allocation is optimised. If this changes the overall project plan, as is shown at 96, then the originating management system 80 receives data manually in the case of data entry and interactive interface options 84 and 86, or electronically in the case of remote data import 88. The process is completed once the overall project plan is settled and individual allocation of the tasks has been optimised.

In an alternative preferred automated version of the invention, shown at 100, the new project management system allocates tasks to human resources automatically using an optimisation routine. In the optimisation routine the system will allocate tasks to people to ensure the project timeframes are met without over allocation of any single resource. Once optimisation has been applied, the project manager and people on the project can review the suggested allocations and amend or accept as appropriate. This facility should not be relied on as the definitive project plan until it has been reviewed and approved by the project manager and affected staff.

System Overview

The stage when tasks have to be assigned to resources can initially be done with a standard box frame screen, by entering the task identifier against the required resource. A ‘click-and-drag’ facility is alternatively developed to handle the assigning of tasks as is shown at 92 in FIG. 4. The end result will be the ability to view and print reports. The relational database which is incorporated into the system uses BLOB's (where the data is compressed in Binary Large Objects) to prevent users making direct changes and to preserve product integrity.

The various steps involved in entering, modifying and deleting tasks; entering, modifying and deleting resources; allocating tasks to resources and entering timing considerations (including milestones, and mandatory or agreed dates) will now be set out in more detail.

The relational database structure 36 of FIG. 5 is used in this process. Task table 10 includes various fields, each of which are listed in the table. Task resource requirement table 112 enables tasks in task table 110 to be matched up to resource requirements in this table, and shares a common task ID field with task table 110. Additional tables include project overhead label table 114, and resource table 116, which is the primary and governing table in the relational database, in the sense that resource fields in this table are linked to other fields in the relational database in a one-to-one or one-to-many relationship. Optional tables include people skills table 118, resource type table 120 and industry label table 122. Role label table 124 illustrates the roles of the various resources, and resource task table 126 includes resource, time and task fields. Project parameter table 128 includes various time parameter fields, and special date table 130 includes various date fields, including start and end dates. Date label table 132 includes fields indicating various date types.

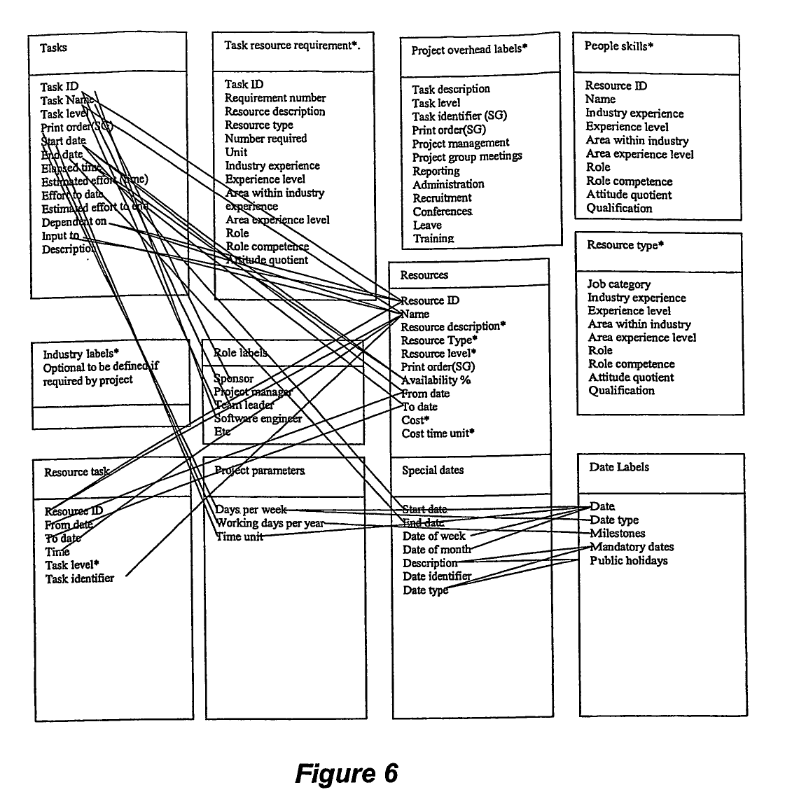

Label tables are filled in at the commencement of each project and remain static throughout. Once set up they provide an automatic display to the project delivery display. The fields in the various tables are interrelated, as is clear from their descriptors. The relational database is designed such that all fields are tagged so that scripts can be written to cause reports to be generated. The various links or relationships in the relational database may be one-to-one or one-to-many. FIG. 6 shows a selection of typical links that can be implemented.

Enter/Modify/Delete Tasks

The steps involved in entering, modifying and deleting task tables in the relational database can be summarised as follows:
List major tasks (work groups) (Several levels may be required)
Note dependencies for each task (each task can have multiple dependencies)
Estimate effort and elapsed time for each task
After the major tasks have been entered, sub tasks need to be entered under the appropriate major task heading, to complete the full list of tasks that form a work group
After known resources have been allocated to tasks (see below) it is likely that some tasks will remain unallocated in the initial stages. At that time the tasks are likely to have to be re-grouped in a different order to assist in determining the resources required
The task description will be used to develop position descriptions

Tables/Fields required in the relational database include task table 110, task resource table 112, and project overhead label table 114.

Note: The Task Identifier should be system generated and include an initial character (e.g. ‘T’) to show it is a genuine active task on the project. Other task identifiers will be included in tables to indicate a repetitive project overhead task (‘O’) and to provide descriptions for why a resource will not be available to the project (‘U’).

Enter/Modify/Delete Resources
A known resource can be allocated to the project
A maximum percentage of time that any resource is available to the project needs to be assigned. This includes facility to allow for the percentage of time to change over the life of the project
A percentage of time any resource is allocated to specific tasks such as Project Management, Reporting, Admin, Recruitment, Giving Training, Receiving Training, Conferences, Leave (Rec, Sick, Special), Other needs to be assigned. This includes a facility to allow for the percentage of time to change over the life of the project
A linear picture of work groups and dependencies while entering resource information needs to be viewed

Tables/Fields Required in the relational database include resource table 118 and a sub-resource table (not shown but listed below with relevant fields).

Note: The Resource Identifier should be system generated and include an initial character (e.g. ‘P’) to indicate a person on the project. Other resource identifiers will be included to indicate other non-human related resources required by project such as ‘H’ for hardware, ‘S’ for Software, etc. A sub-resource category is required for resources that are specifically related to another resource. For example each person will require such items as a phone line, PC, site access rights, etc. The format of a typical sub-resources table is listed below.

Sub-Resources Table:

ResourceDescription/ResourceType/ResourceIdentifier(SG)/PrintOrder/PercentageAv/FromDate/ToDate/HigherLevelResourceIdentifier

Allocate Task to Resources

This needs to be done on a user interface screen of the type indicated in FIG. 3C. ResourceTask Table 126 is used for this purpose.

Enter Timing Considerations (Milestones, Mandatory, or Agreed, Dates)

Each milestone is to have a unique identifier.

Project parameter table 128 is used in conjunction with special dates table 130 and date label table 132 for the entry of all timing considerations.

Reports

1. List of tasks by work group

2. Timeline report by major task groups showing dependencies(*)

3. Sub-timeline report for sub-tasks showing dependencies(*)

4. List of resources with tasks laid out in time order

5. List of resources with tasks laid out in task groups (for export to position description/project contract

6. Discrepancy report (including orphan tasks, over/under allocation of resources)

7. Progress by Task

8. Progress by Resource

9. Percentage allocation of time per resource

10. Critical Path

11. Progress Variance (where actual progress varies from the estimate) Need to summarise variance in actual days & show impact on the project.

* to show pre, post and co dependencies

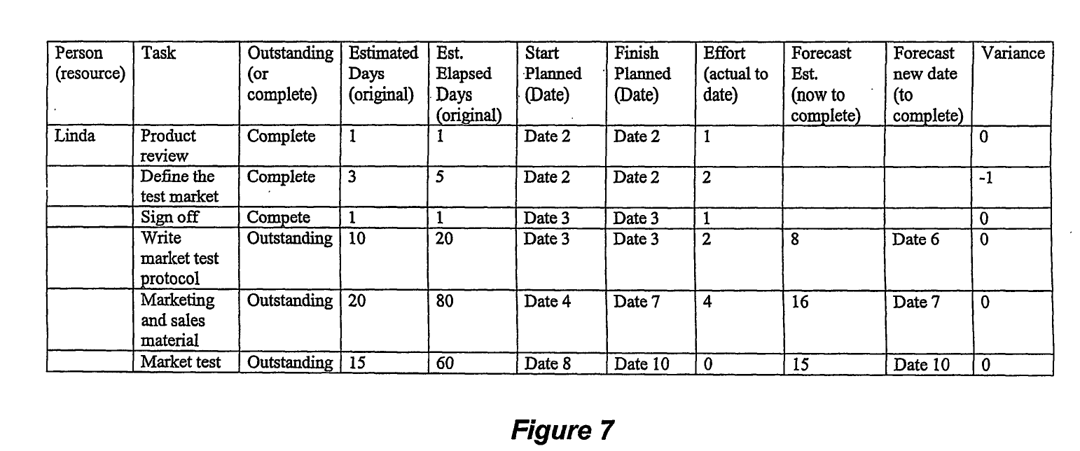

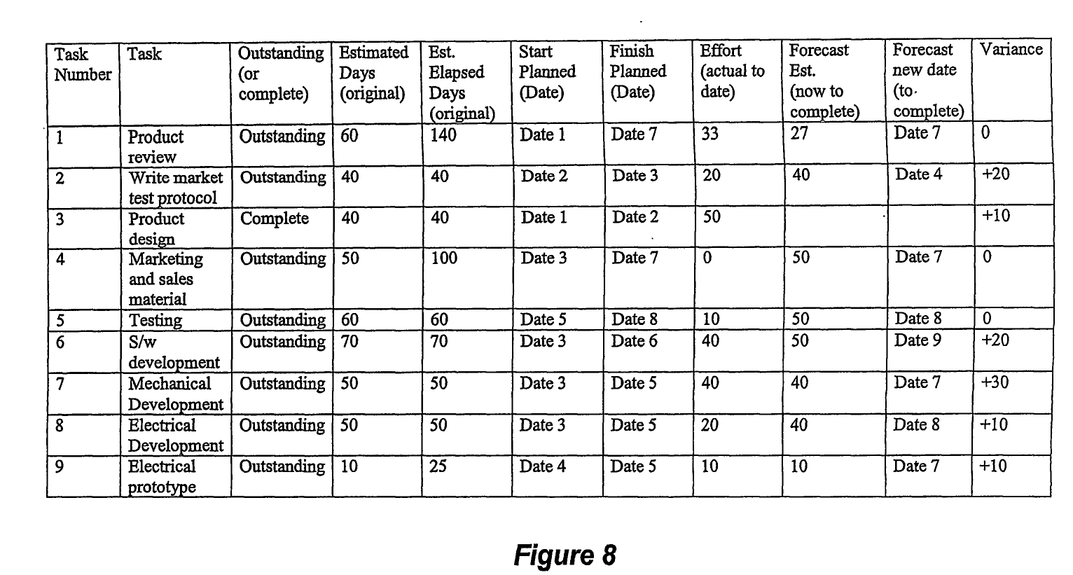

A sample progress report by person or resource is shown in FIG. 7, and a similar report by task is shown in FIG. 8. These reports need to highlight where dependencies come in.

Data Export Facility

In addition to viewing each report from the user interface 38, and printing them, a facility will be provided to export the data in each report in XML format.

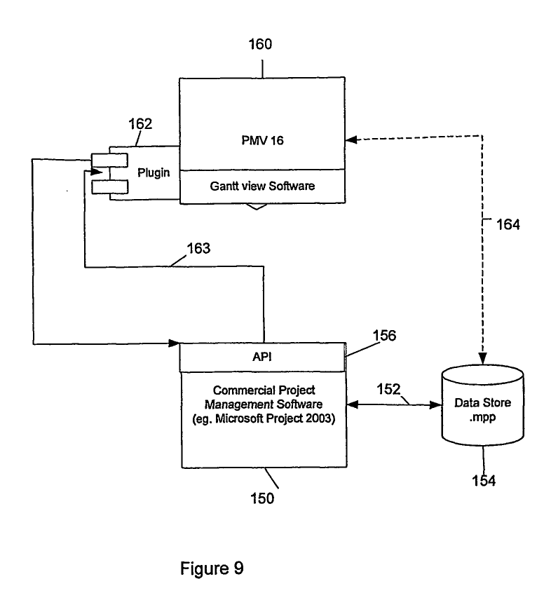

Turning now to FIG. 9, known project management software 150, in this case Microsoft Project®2003 is able to communicate 152 with a relational data store 154 and includes an Application Programming Interface (API) 156. The known project management software may include other similar implementations that are well known to a skilled addressee in the relevant art, such as Primavera®. The relational data store 154 is in the form of an .mpp file. The data store 154 may alternatively be implemented as an SQL compliant database or may be an XML file.

A resource-based software application of an embodiment of the present invention 160 is able to interact with the known project management software via a plug-in 162. This plug-in is able to retrieve information 163 from the known project management software 150 (and its associated data store 154) through the Application Programming Interface (API) 156 which is specific to that known software (in this case Microsoft Project 2003®) and create an instance of the currently active project data. Alternatively, the software application 160 may be implemented to interface directly 164 with the data store 154, however, this is significantly more cumbersome.

The software application 160 then reorganises the data of the specified instance into a resource orientated data store in a manner further described below. This resource oriented data store is passed to a third party Gantt charting software package 166 which may be an ActiveX® control such as such as VARCHART XGantt 3.1, accessible from www.netronic.com. to produce a modified Gantt chart. Various other packages may be used to produce a Gantt chart from the resource-centric data that is produced by the application 160.

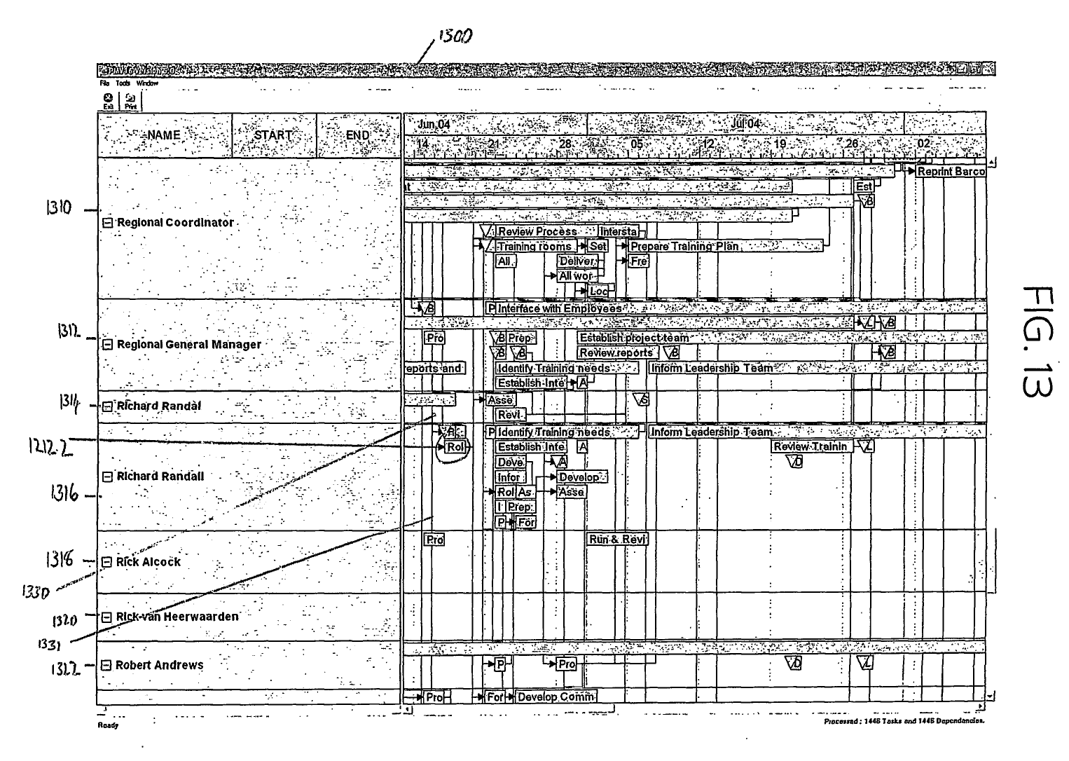

The Gantt charting software 166 accesses the resource-centric data to produce a modified Gantt chart (FIGS. 13-18), with resources instead of events listed down the rows of the leftmost column, and the various dates and milestones indicated in the uppermost row of the chart, with bars indicating the duration of each task, and arrows indicating the dependencies associated with each task.

The resource-based software application of an embodiment of the present invention 160 may be integral with or separate from the known project management software, and may be initialised from within an active session of a known project management software session, for example by activating an icon or by some other means well known in the art. Alternatively, the software of an embodiment of the present invention 160 may be initialised and operated as a separate program under any of the well known operating systems available, for example Windows® or Linux or variations on these. The software of the present invention may be written in any of the common object orientated languages including but not limited to C#, C++, and Java.

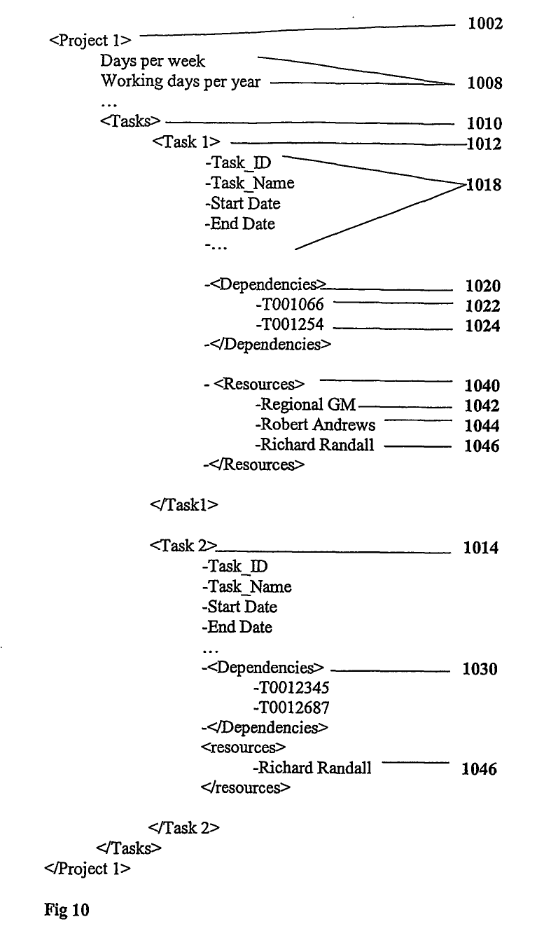

A high level representation of an hierarchical data structure 1002 for typical data captured in the data store for implementations of known project management software is shown in FIG. 10. Each project has a number of fields associated with it (which may include days per week, working days per year and so on 1008) and is made up of a collection 1010 of tasks, for example 1012, 1014. A selection 1018 of typical data associated with a task is represented for task 1 and may include data such as Task_ID, Task_Name, and Start_date as shown in FIG. 5 at 112. Each task may also include a collection of taskIDs on which it depends 1020, 1030 i.e. tasks which must be completed before that task may be commenced, for example for Task 1 this is Task0001066, Task001254 (1022, 1024).

Each task further includes a collection of resources 1040 allocated to that task The resources may be positions, teams or people—in this example Regional GM, Robert Andrews, and Richard Randall (1042, 1044, 1046 respectively). In the case of Task 2, 1014 it can be seen that only Richard Randall 1046 is allocated.

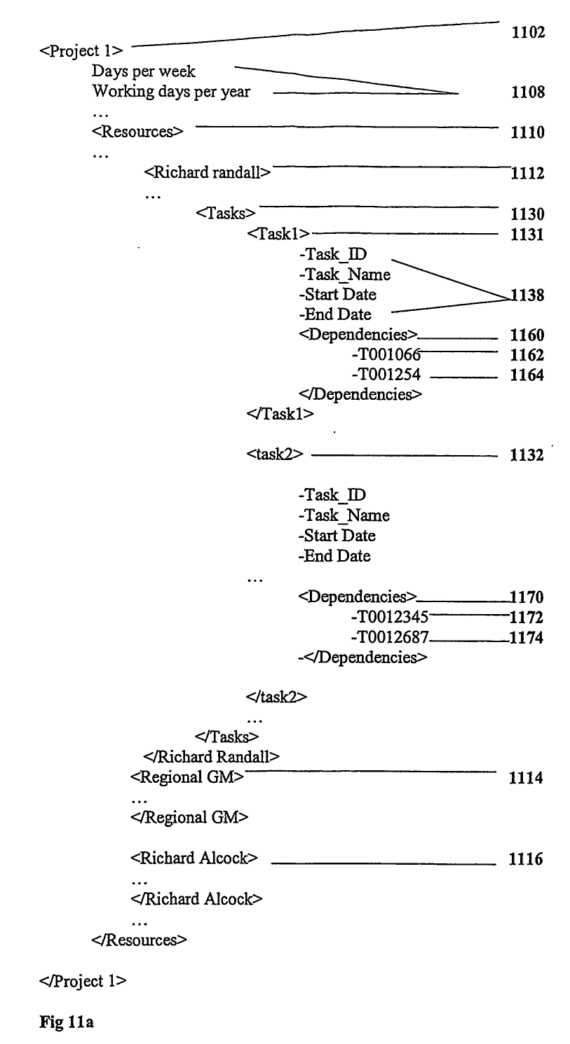

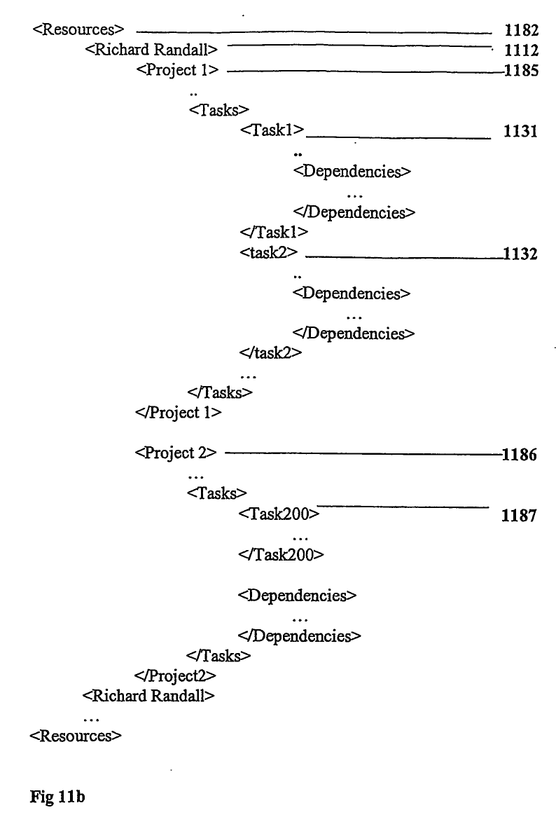

Referring now to FIG. 11a, a hierarchical data structure of an embodiment of the present invention is shown at 1102. Each project in FIG. 11a has a number of fields associated with it 1108 (including Days per week, Working days per year and so on). Each project is made up of a collection 1110 of resources, for example Richard Randall, Regional GM, and Richard Alcock (1112, 1114, 1116 respectively). Each resource is associated with a collection of tasks 1130. In the Example, Richard Randall is associated with tasks 1 and 3 (1131, 1132 respectively).

A selection of typical data associated with a task is represented for task 1 and task 2 at 1138 and 1140. These data fields may include data such as Task_ID, Task_Name, Start_date (as shown at 112 in FIG. 5). Each task may also include a collection of taskIDs on which it depends 1160, 1170. For task 1 and task 2 respectively tasks which must be completed before that task may be commenced are for example 1162, 1164 (Task001066, Task001254) and 1172, 1174 (Task 0012345, Task 0012687) respectively.

Similarly, a hierarchical data structure of an embodiment of the present invention is shown in 1182 of FIG. 11b. This data structure may be produced in one aspect of the present invention where resources are involved in a plurality of projects, and task and timing information relating to those projects is captured by known project management software. As can be seen for resource 1112, Richard Randall is involved in Project 1 1185, in task 1 1131 and task 2 1132, which both have associated timing and other information, as well as dependency information (as exemplified by FIG. 11(a) but not shown in the present representation). Resource 1112, Richard Randall, is also involved in Project 2 1186 in task 200 1187, again having associated timing and other information (as exemplified by FIG. 11(a) but not shown in the present representation).

It can be seen that an aspect of the present invention lies in the reorganisation of the data structure, from a task-centric perspective, with an associated collection of resources required to perform that task, to a resource-centric perspective, with each resource of the collection associated with one or more tasks required for the project. To this end, it can be seen from FIGS. 11(a) and 11(b) how all task, timing and dependency data associated with a particular resource are made a subset thereof.

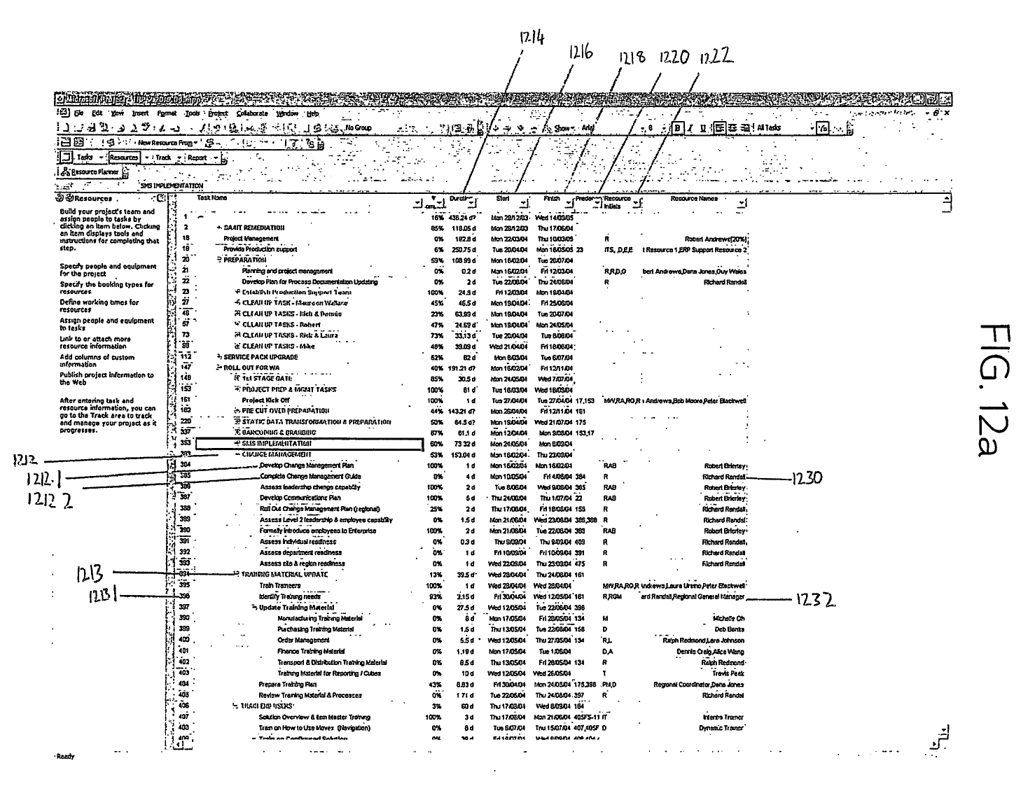

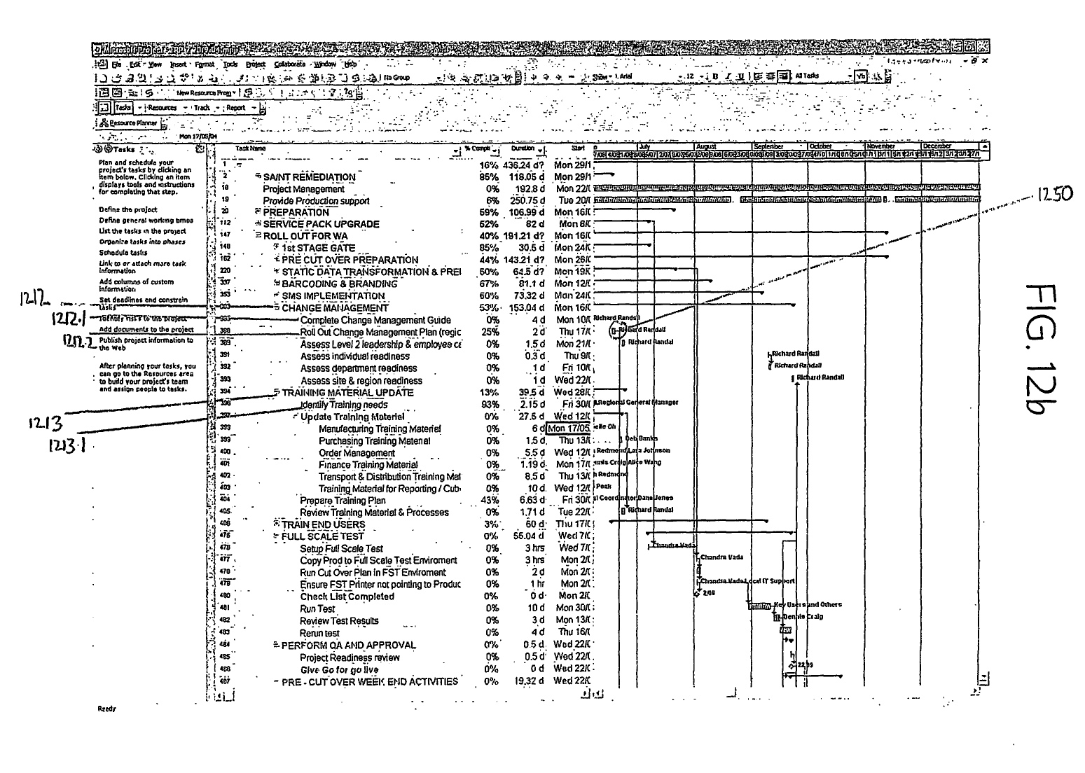

FIG. 12a shows the data used in the production of a typical Gantt chart using known project management software. A series of broad tasks 1212 and 1213 etc are listed in the task column. Each task may be divided into more detailed sub-tasks e.g. 1212.1 to 1212.5, and 1213.1. Each task may have duration 1214, start 1216 and end 1218 dates, dependencies indicating which task(s) must be completed before this task can commence 1220 and a resource (1222) associated with it. In the case of sub-task 1212.2 the resource allocated is Richard Randall 1230. Similarly, in the case of sub-task 1213.1 the allocated resource is Richard Randall and the Regional General Manager 1232.

FIG. 12b shows the Gantt chart produced from this information using known project management software (for example Microsoft Project 2003®). Again a series of broad tasks 1212 and 1213 etc are listed in the task column. Each task may be divided into more detailed sub-tasks e.g. 1212.1 to 1212.5, and 1213.1. Each task may have duration 1214, start dates 1216,1220 and a resource 1222 associated with it. Also, the Gantt chart-type representation appears next to it, with resource names appearing next to events/milestones on the chart. It can be seen that Richard Randall is responsible for task 1212.2, which has certain dependencies (represented by arrows 1252) and other features in accordance with well known principles for representing the various stages of project management.

A simplified version of typical Gantt chart is included as FIG. 1 of the present application, as previously described.

FIG. 13 shows a screen shot 1300 of a modified Gantt chart in accordance with a preferred aspect of the present invention which is produced from the information provided in FIG. 12a. It can be seen that the chart is organised according to human resource (rather than task view as is the case in FIG. 12a). Each resource in the leftmost column e.g. Regional Coordinator, Regional General Manager, Richard Randal, Richard Randall, Rick Alcock, etc (1310, 1312, 1314, 1316, 1318 respectively) has an associated task or tasks with specific timeframes. For example, the Resource Richard Randall 1316 has task 1212.2 allocated to it, which is dependent on a number of other tasks, demonstrated by the arrows 1330, 1331. In turn, task FO is dependent on task 1212.2.

Users may be assisted in determining the nature of the dependency of tasks through the use of colour or other means of coding the visual representation of the dependency links such as similar arrays of dashed or hatched lines through, say, independent individual tasks.

The software of an embodiment of the present invention may also include a facility to allow a particular resource to specify their approximate level of completion of a particular task, in the underlying data structure that is associated with an embodiment of the present invention. Colours or shading may be used to represent an approximate level of completion of the task by the resource, thereby enabling personnel to obtain a high level, rapid overview of the ongoing progression of the project. For example, tasks which have not yet started may be black, 50% completed tasks may change colour from black to blue, and completed tasks may change from blue to green. Alternatively, the extent to which each task is completed may be represented by the extent to which the corresponding task box has been coloured in.

Additionally, software of the present invention may further include the facility whereby the critical path may be colour coded, and tasks and dependency links forming part of the critical path are able to be highlighted using a particular colour—for example red. As is well known in project management, the critical path is the chain of tasks that determine the duration of a project, and emphasising tasks and dependencies on this path can be a useful technique to minimise slippage.

Not shown but also helpful for project managers and particular resources would be a facility which allowed the tasks and timing information for a particular resource to be reviewed in isolation. This facility would allow users to print out particular upcoming tasks or in other circumstances. Using this facility, resource Richard Randall may be able to view and print only tasks and timing that had been allocated to him.

The software of an embodiment of the present invention may also include a feature which allows both colour coding and/or linking into groups of human resources which have similar skillsets—e.g. all Project Engineers able to commission new machinery may be represented by green, and be linked together.

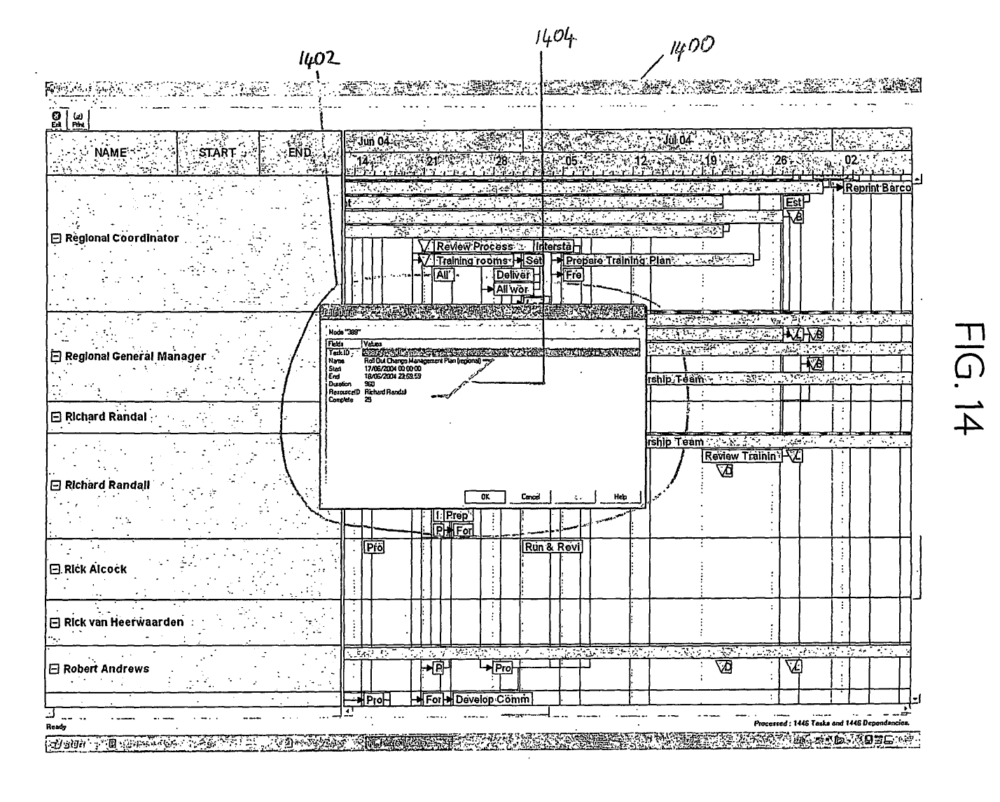

FIG. 14 shows a screen shot 1400 of an aspect of the present invention where the Task 1212.2 is active (for example selected and right clicked or some other well known mechanism including mouseover or ‘hovering’ over the task hot spot for a predetermined length of time. ). Information associated with that task is displayed on a ‘popup’ 1402, including Task ID, TaskName, Start and EndDates and Completion percentage (collectively 1404).

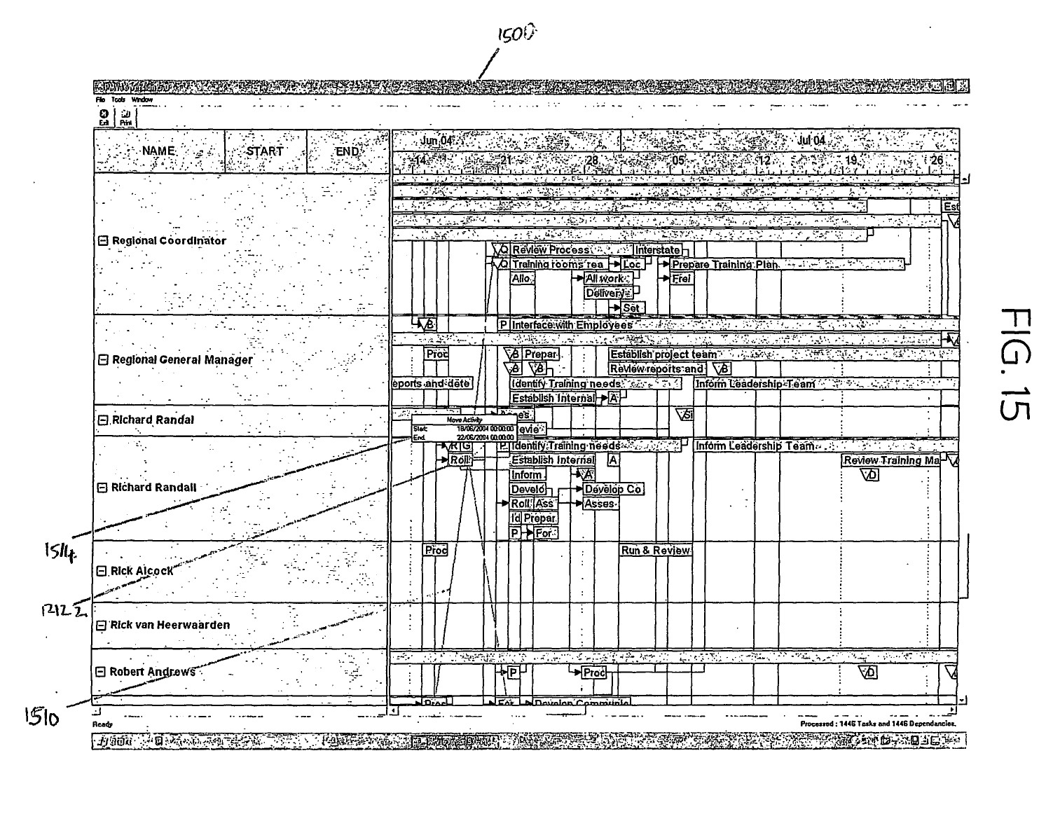

FIG. 15 shows a screen shot of one embodiment of the present invention 1500 demonstrating that the user has selected Task 1212.2 and wants to reallocate that activity to another resource. It can be seen that the dependencies associated with this task are represented by the ‘greyed’ out lines shown in 1510. The current start date and end date are shown to the user by a pop-up box 1514 when that task is selected (for example by clicking on it with a mouse).

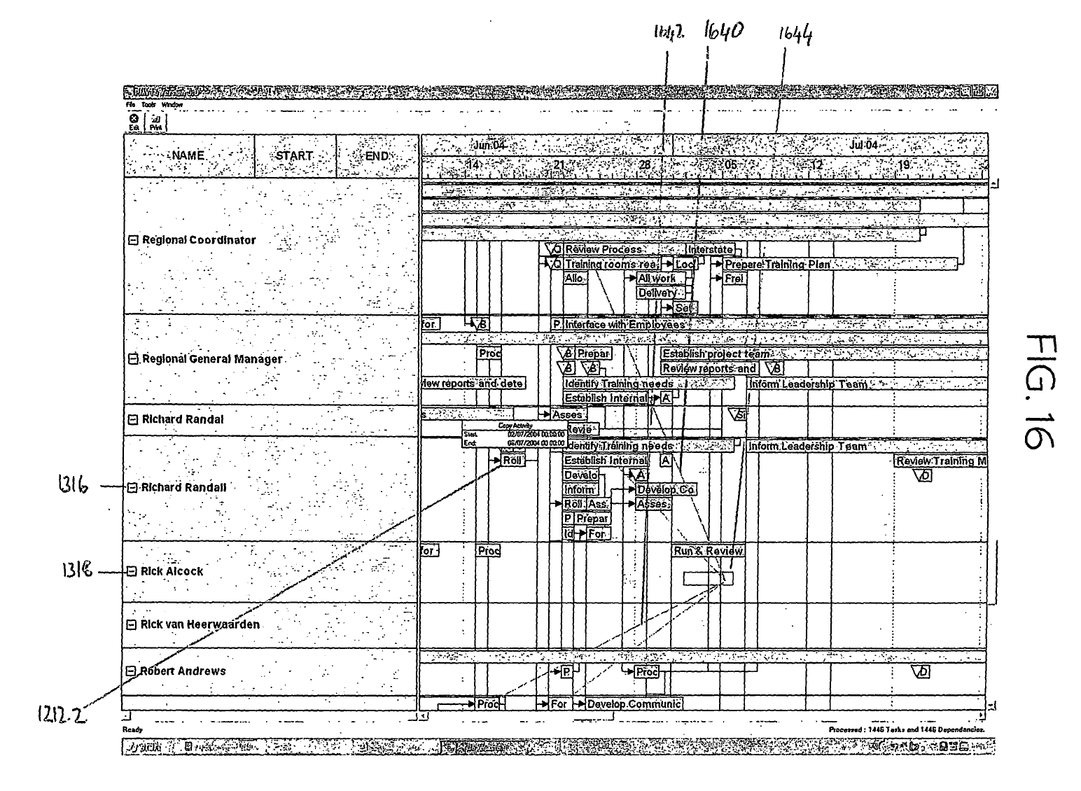

FIG. 16 shows a screen shot 1600 of one embodiment of the present invention showing the desired reallocation of task 1212.2 from resource Richard Randall (1316) to resource Rick Alcock (1318). It can be seen that this represented by ‘greyed out’ lines 1640, 1642 and the greyed out box 1644. At this point, the software program of the present invention can check that this does not breach certain rules associated with business logic. By way of non limiting example, this may include preventing the timeframe for carrying out task 1212.2 being altered to after the date of tasks which are dependent on it. Another rule that could be included in the software is not to allow the reallocation of completed tasks.

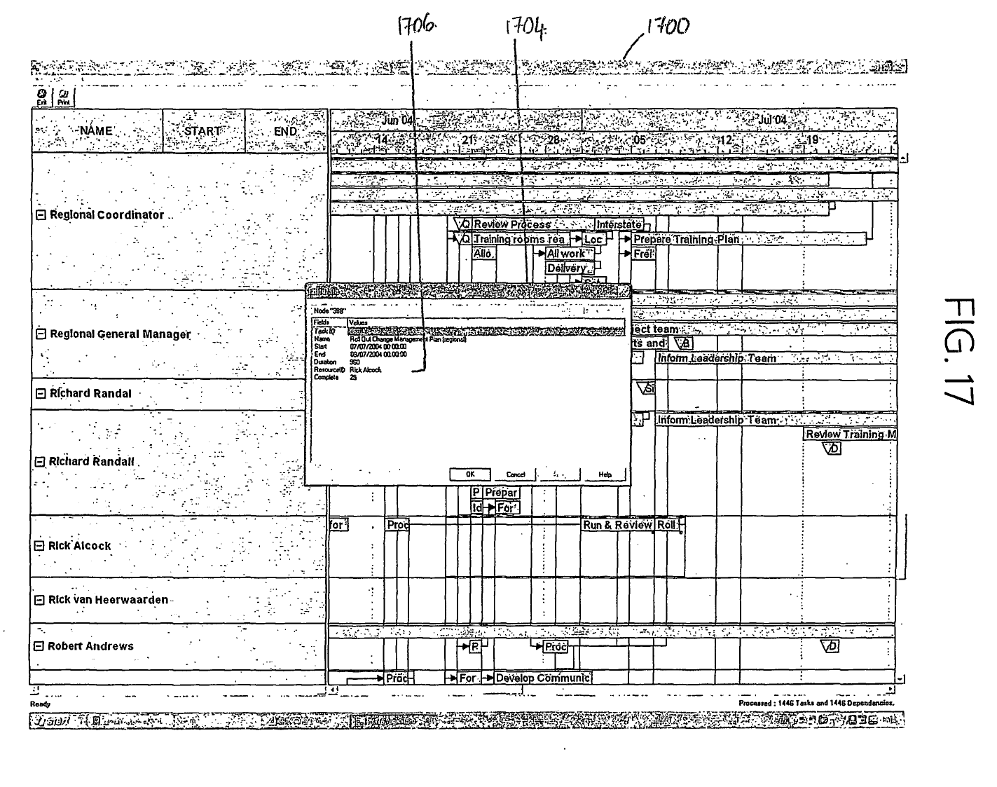

FIG. 17 shows an a screen shot 1700 of one aspect of the present invention where task details for task 1212.2 are presented to the user in a pop-up box 1704, confirming that the task has been reallocated from Richard Randall to Rick Alcock as is identified by 1706.

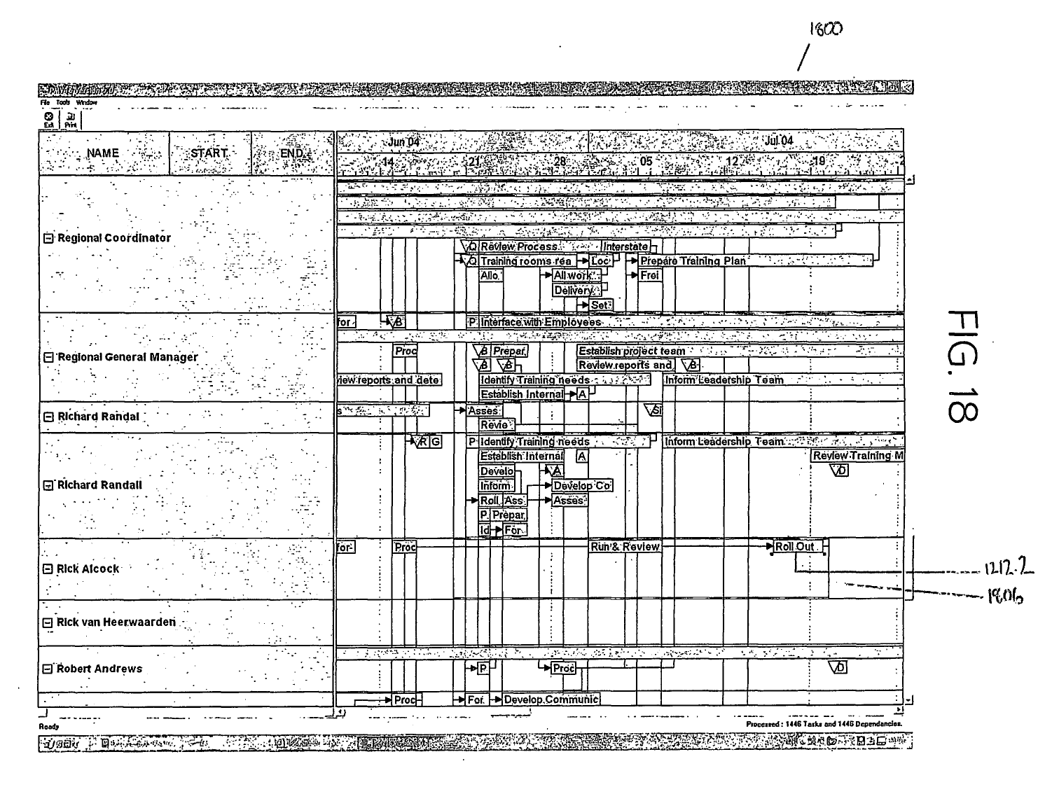

FIG. 18 shows a screen shot 1800 of one aspect of the present invention which shows the re-allocation of task 1212.2 to another resource, Rick Alcock, and the consequent adjustment of associated dependencies 1806.

When a user is satisfied with this allocation, this change may be saved to the instance of the data structure associated with the resource-centric project management software of the present invention in accordance with well known procedures in the art. In turn, this change may be propagated back to the underlying data structure of the original active session of the known project management system.

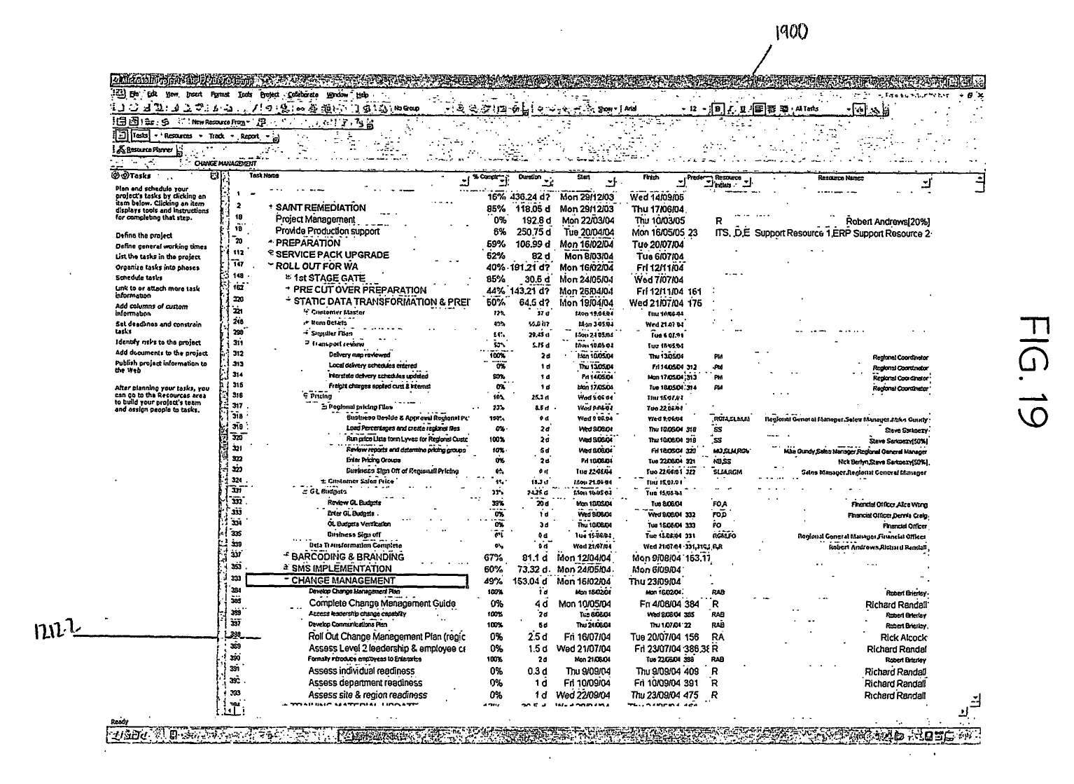

Accordingly, FIG. 19 shows a screen shot 1900 of the Resource Planner view of a known project management software system which demonstrates that task 1212.2 has been allocated to Rick Alcock, a modification of the initial state shown in FIG. 11.

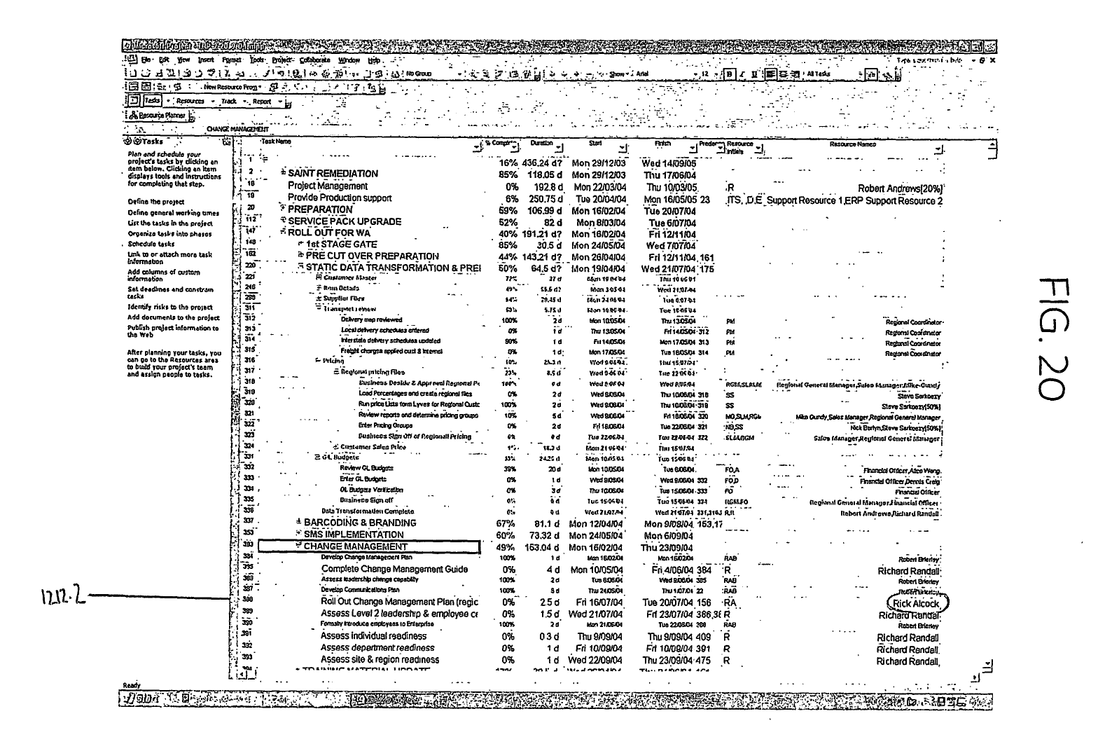

FIG. 20 shows a modified resource allocation in the context of the overall project plan, in which task 1212.2 is allocated to Rick Alcock C(his may be compared to the initial state shown in FIG. 12).

It will be understood by a person skilled in the art that the method, software and system of the present invention could all be implemented in a manner such that the reorganisation and graphical presentation of the data set of known project management software (as described in the present invention) may take place on the same computer. However, it will also be appreciated by a person skilled in the art that alternative arrangements exist.

By way of non-limiting example, the reorganised data structure may be uploaded over a network from a project manager's computer, to a central repository or web server. This data structure may then be access and a graphical representation conveyed to a plurality of remote users communicating with the web server over a network such as the WAN, LAN internet or the like. Well known role based access control methods (for example using user Identification and password controls) may be used to control read, write, and modify access to the data of that data store.

Alternatively, a project data set may be communicated to the central repository where it may be reorganised from a task-centric data structure to a resource-centric data structure in accordance with an aspect of the present invention, and then made accessible to a plurality of remote users over a network.

For example, if the known project management software used is Microsoft Project 2003®, it is well known in the art for a project manager to publish task assignments to a Microsoft Enterprise server platform, for access by a remote team members over a wired or wireless network such as the internet, WAN, LAN or the like. Remote project team members are able to interface and update the information published to the server platform by a Project Manager using the Project Web Access application.

It will be appreciated that the in traditional project management, there is a task focus, whereas in the embodiments of the project management system of the invention, there is a human resource focus in which people are very clear about expectations. In a typical project management scenario problems are often hidden until one of the final stages rather than becoming evident at an early stage. The project management system and method of the embodiments of the present invention tends to foster realistic planning and ownership in the plan and tends to be adopted by each person on the project rather than seen as being owned by project management. The system of the embodiments of the present invention also provides little room for unintentional over-allocation of people.

The present invention also allows people to work to achieve tasks that are clear and set in the overall context of an outcome, rather than working for an abstract project. Essentially, the present invention employs the philosophy that people like and need to know exactly what they need to do when, exactly what individual support they need to provide to others, and what other individuals need to provide to them. By looking at projects from the perspective of the people doing the project, there is an increase in focus on individual performance and responsibility. Any over-commitment or lag can readily be ascertained in a resource-based system of embodiments of the present invention. The embodiments of the present invention further provide a tool for assisting in driving delivery through individuals knowing what they have to do and when, rather than merely serving as a reporting tool to assist in explaining slippage.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

1. A computer-based method for facilitating the management of a project including:
providing a project management database configured to receive a plurality of entries, including a series of tasks or events and a series of attributes associated with the tasks or events, the attributes including time-based attributes indicating the timing of the tasks or events, and resource-based attributes indicating at least the human resources allocated to the tasks or events;
generating at least a resource-centric display interface from the database in which each human resource is listed against its associated tasks, time-based attributes and task-related dependency links in a one-to-many relationship;
storing entries in the database; and
compiling a project management plan in which tasks, associated time-based attributes and dependency links are grouped in respect of each human resource.

2. A computer based method for facilitating the management of a project as claimed in claim 1 wherein the method includes iteratively:
generating and displaying project sub-plans for each individual human resource,
enabling the project sub-plans to be modified, and
combining the modified sub-plans into an overall modified project management plan in which the tasks dependency links and associated time-based attributes are listed for each of the human resources.

3. A computer-based method for facilitating the management of a project having a series of tasks or events, said method comprising:
receiving task data, associated resource data, associated timing data and associated task-related dependency data, said data being arranged to be viewed in a task-centric manner through a task-centric display interface in which each for each task all corresponding resources are grouped;
for each resource, grouping all corresponding task, timing and task-related dependency data,
graphically representing said grouped data on a resource-centric display interface from a resource-centric perspective so that for each resource the task, timing and task-related dependency data is collectively displayed relative to said resource in a one-to-many relationship.

4. A computer-based method for facilitating the management of multiple projects, each project having a series of tasks, said method comprising:
receiving a plurality of project management datasets, each dataset including project data, task data, associated resource data, associated timing data and task-related dependency data with said data being viewable through a task-centric graphical interface,
for each resource, grouping all corresponding task, timing and dependency data,
graphically representing said grouped data on a resource-centric interface so that for each resource, the project, task, timing and dependency data is collectively displayed in a one-to-many relationship relative to said resource.

5. A computer-based method for facilitating the management of a project having a series of tasks or events as claimed in claim 4 wherein the method includes, at a resource-centric level, enabling individual tasks to be re-allocated to other resources, typically via a resource-centric interface.

6. A computer-based method for facilitating the management of a project having a series of tasks or events as claimed in claim 4 wherein the method includes enabling said resource-centric project management dataset to be alternately displayed in a task-centric format, where for each task the resource and timing data is collectively displayed.

7. A computer-based method for planning a project including:
receiving a project management dataset including task data, associated human resource data and associated timing data,
for each human resource, grouping all corresponding task, timing and dependency data,
providing a resource-centric interface wherein said grouped data is graphically represented from a resource-centric perspective so that for each resource, the task and timing data are collectively displayed relative to said resource in a one-to-many relationship,
capturing modifications to said graphical representation and adjusting at least one of corresponding task and timing data,
storing at least one of modified task and timing data.

8. A computer-based method for planning a project including:
receiving a project management dataset including task data, associated human resource data, associated timing data and associated task-related dependency data;
deconstructing and regrouping the project management dataset for each human resource so that it is grouped with its corresponding task, timing and dependency data,
graphically representing said grouped data so that for each resource, the task, timing and dependency data are collectively displayed relative to said resource in a one-to-many relationship.

9. A computer based method of facilitating the management of a project as claimed in claim 1 wherein the dependency links are linked both to tasks allocated to the same human resource as well to tasks allocated to other human resources.

10. A computer based method for facilitating the management of a project as claimed in claim 1 wherein at least some of the human resources are comprised of teams of individuals who may be assigned to sub-projects.

11. A computer based method for facilitating the management of a project as claimed in claim 1 wherein resources-based attributes include non-human resources required in the implementation of the project, chosen from a group including equipment, supplies, premises, and associated costs.

12. A computer based method for facilitating the management of a project as claimed in claim 1 wherein both the project management plan and the individual plans making up the project management plan are arranged in a Gantt chart-type format, with each resource and associated task and timing data being row-specific.

13. A computer-based method for facilitating the management of a project having a series of tasks or events as claimed in claim 1 wherein said task data is represented as a series of tasks, and said task-related dependency data is represented as a series of incoming and outgoing dependency links, each incoming link originating from tasks allocated to a human resource on which a particular task depends, and each outgoing link being directed to a task depending on said particular task.

14. A system for facilitating the computer-based management of a project, having a series of tasks, said system comprising:
a data store for storing a project management dataset, said project management dataset including task data, resource data, timing data and dependency data;
a task-based project management application which is arranged to access said data store, and to allow the graphical display and manipulation of said dataset in a task-centric manner, in which said application graphically displays the associated data for each task,
a resource-based project management application which is arranged to access said data store, and which groups for each resource all corresponding task, timing and dependency data in a resource-centric manner, so each resource is linked with its task and timing data in a one-to-many relationship, and
a graphical representation component for graphically representing said resource-centric data such that each resource is linked with its tasks, timing and dependency data in a one-to-many relationship.

15. A system for facilitating the computer-based management of a project having a series of tasks, said system comprising:
a project management application which stores a series of data on tasks in a first data store, each task having associated resource, timing and dependency data, said application graphically displaying data associated with each task in a task-centric format,
a function integrated within the project management application which is able to access the said first data store, and which aggregates data associated with each resource and stores it in a second data store, so that each resource is linked with its task, timing and dependency data in a one-to-many relationship,
a graphical representation means adapted to generate a graphical representation of either the first or second data stores, and
a switching application for switching between graphical representations of the task-centric or resource-centric views.

16. A system for facilitating the computer-based management of a project having a series of tasks, said system comprising a data store for storing a project management dataset, said project management dataset including task data, resource data dependency, and timing data, and
a task-based project management application which is arranged to access said data store, and to allow the graphical display and manipulation of said dataset in a task-centric manner, in which said application graphically displays the associated data for each task, and
a resource-based project management application which is arranged to access said data store, and which is arranged to group for each resource all corresponding task and timing data in a resource-centric manner, so each resource is linked with its task and timing data in a one-to-many relationship, said application including or interfacing with a graphical representation component for graphically representing said resource-centric data such that each resource is linked with its tasks, timing and dependency data in a one-to-many relationship.

17. A system for facilitating the computer-based management of a project, having a series of tasks, said system comprising:
a data store for storing a project management dataset, said project management dataset including task data, resource data, timing data and dependency data;
a graphical user interface application for accessing said dataset, graphically displaying the associated data for each task and manipulating said dataset in a task-centric manner,
a resource-based project management application for reorganising and updating said dataset, said reorganising and updating including grouping task and timing data in a resource-centric manner, so each resource is linked with its task and timing data in a one-to-many relationship,
a graphical representation component for graphically representing said resource-centric data such that each resource is linked with its task, timing and dependency data in a one-to-many relationship.

18. A system for facilitating the computer-based management of multiple projects, each project having a series of tasks, said system comprising:
a plurality of data stores for storing a plurality of project management datasets, each dataset including project data, task data, associated resource data and associated timing data,
a resource-based project management application which is arranged to access said plurality of data stores, and which is arranged to group for each resource all corresponding task and timing data in a resource-centric manner, so each resource is linked with its task and timing data in a one-to-many relationship,
a graphical representation component for graphically representing said resource-centric data such that for each resource, project, task, timing and dependency data for that resource across each project is collectively displayed in a one-to-many relationship relative to said resource.

19. A system as claimed in claim 18 wherein the system includes a plurality of display interfaces, each display interface having individual human resources listed against events or tasks associated with that resource.

20. A system as claimed in claim 14 wherein the system includes a link inserter for enabling dependency-based links to be inserted between dependent tasks or events associated with the human resources.

21. A computer readable medium having stored thereon executable instructions for causing a computer to perform a method according to claim 1 and for interacting with a database.

22. A computer readable medium containing program code, the program code being operative to instruct at least one programmable processor to execute the project management method according to claim 1.

23. A computer readable medium containing program code, the program code being operative to instruct at least one programmable processor to execute a resource-based project management application which is arranged to access a data store associated with a project, and which is arranged to group for each resource in that project all corresponding task, timing and dependency data in a resource-centric manner, so each resource is linked with its task, timing and dependency data in a one-to-many relationship, said application including or interfacing with program code capable of graphically representing said resource-centric data such that for each resource, task, timing and dependency data for that resource, is collectively displayed in a one-to-many relationship relative to said resource.

24. A computer readable medium containing program code, the program code being operative to instruct at least one programmable processor to execute a resource-based project management application which is arranged to access data stores associated with a plurality of specified projects, and which groups for each resource all corresponding task, timing and dependency data in a resource-centric manner, so each resource is linked with its task, timing and dependency data in a one-to-many relationship, said application including or interfacing with program code capable of graphically representing said resource-centric data such that for each resource, project, task, timing and dependency data for that resource across each project, is collectively displayed in a one-to-many relationship relative to said resource.

25. A computer readable medium having stored thereon executable instructions for causing a computer to perform a method according to claim 3 and for interacting with a database.

26. A computer readable medium containing program code, the program code being operative to instruct at least one programmable processor to execute the project management method according to claim 3.

27. A computer readable medium having stored thereon executable instructions for causing a computer to perform a method according to claim 4 and for interacting with a database.

28. A computer readable medium containing program code, the program code being operative to instruct at least one programmable processor to execute the project management method according to claim 4.

29. A computer readable medium having stored thereon executable instructions for causing a computer to perform a method according to claim 7 and for interacting with a database.

30. A computer readable medium containing program code, the program code being operative to instruct at least one programmable processor to execute the project management method according to claim 7.

31. A computer readable medium having stored thereon executable instructions for causing a computer to perform a method according to claim 8 and for interacting with a database.

32. A computer readable medium containing program code, the program code being operative to instruct at least one programmable processor to execute the project management method according to claim 8.
